(19) United States
(12) Patent Application Publication
(10) Pub. No.: US 2001/0042016 A1
(43) Pub. Date: Nov. 15, 2001

(54) Local portal

(76) Inventors: Matthew R. Muyres, Felton, CA (US); Joel R. Rigler, Aptos, CA (US); James B. Williams, Santa Cruz, CA (US); Harold L. Peterson, Los Gatos, CA (US)

Correspondence Address: Oppenheimer Wolff & Donnelly, LLP, 1400 Page Mill Rd., Palo Alto, CA, 94304, US

(21) Appl. No.: 09/798,503

(22) Filed: Mar. 1, 2001

Related U.S. Application Data
(63) Continuation-in-part of application No. 09/423,025, filed on Oct. 28, 1999.
Application No. 09/423,025 is a continuation of application No. PCT/US98/18948, filed on Sep. 11, 1998.
(60) Provisional application No. 60/058,623, filed on Sep. 11, 1997.

(51) Int. Cl. G06F 17/60

(52) U.S. Cl. 705/14

(57) ABSTRACT

A local portal system including a personal computerized system having a display and a primary storage unit. The primary storage unit is provided with an inventory of local digital content which has been installed before its being received by a user. Logics then operate a persistent desktop object (PDO) which is perceivable on the display by the user and present a presentation of digital content with the persistent desktop object which initially includes at least part of said local digital content.

### CROSS-REFERENCE TO RELATED APPLICATIONS

This is a continuation-in-part of U.S. application Ser. No. 09/423,025, filed Oct. 28, 1999, which is a continuation under 35 U.S.C. 371 of application PCT/US98/18948, filed on Sep. 11, 1998, and which claims the benefit of U.S. provisional application serial No. 60/058,623, filed on Sep. 11, 1997.

### TECHNICAL FIELD

The present invention relates generally to the marketing functions of vending and delivery of digital content and services related thereto, and more particularly to interactive computer network systems for such marketing.

### BACKGROUND ART

Today we are seeing a merging of many products and services into digital formats. Some typical examples of such digital products are computer software; audio content, like music or audio-books; and audio-visual content, like videos and movies. For present purposes, the salient feature of such digital products is that they can often be treated as mere bags-of-bits (BOBs), with the underlying nature of the products ignored during most handling after creation and before use.

Somewhat less widely appreciated is that many services are now also digital to a considerable extent. For example, computer users today let applets run tests and communicate the results to providers for obtaining installation, upgrade, and problem diagnosis of operating system and applications software; computer game players send each other hints via e-mail; and Internet “telephone,” “radio,” and “television” are emerging as replacements for specialized telephone and broadcast systems. Thus, often to a considerable extent services today can be reduced to digital communications, and can then also be treated as BOBs, in a somewhat more dynamic sense.

For more stable forms of such digital content it has long been appreciated that the particular storage media used has become largely irrelevant. Tape, disk, and drum media are all common, as are physical, magnetic, and optical means of impressing digital content into them. Similarly, for digital services the channels of communication used have similarly become largely irrelevant. Electrical current through wires, light through fibers, and radiation through space are all common, and substantially interchangeable communications channels.

Of relatively recent advent are communications networks, particularly including public networks like the Internet. Although access to such networks is still not universal, such networks are increasing the trend towards the irrelevance of the underlying media used to store digital products and the medium used to communicate digital services. In the following discussion the collective term “digital content” is used to represent both digital products and digital services.

Because networks are overwhelmingly computerized, and thus those already familiar with computers can be expected to most easily appreciate and readily adopt network storage and delivery of digital content, examples in the context of personal computers will be primarily used (personal computer: “PC”; used here in the broad sense, because even most computers in business today are actually termed PCs). It should, however, at all times also be appreciated that the principles being discussed are valid for and extendable to other contexts.

Turning now to an example of how the potential of digital content is not adequately being employed today, new PCs are usually purchased with some specific task in mind, such as word-processing. However, often the customer also wants to try out new hardware and software capabilities, much like the child in us all likes to immediately play with a new toy. Further, when a consumer purchases a new PC he or she usually also wants to employ it for such intended and experimental tasks almost immediately. It thus is not surprising that studies show that new PC owners are twice as likely to purchase software, as compared to ones who have owned their computers for longer than three months.

Various vehicles for delivery of software for new PCs exist. For example, it can be obtained at the same time as a new PC, or by returning to the store for later purchase. Further, obtaining the software at the same time as the PC can be achieved as a collateral purchase, or it can be obtained as “bundled” software coming with the PC. Unfortunately, there are a number of problems with these methods of delivery.

The collateral purchase of software usually occurs only when the consumer knows exactly what he or she wants, or when the price is within the consumer's impulse purchase price range (i.e., relatively low in price). There are various reasons for this, but some typical ones include the divide and conquer approach to getting a complex system working (including even so-called turn-key PCs today), and the palatability of separating hardware and software costs (which are substantial, particularly together).

In theory, the bundled approach to software delivery seems quite desirable. The consumer gets pre-installed working software, and economy of scale keeps the price for this low. Unfortunately, theory and reality do not mesh well here, and the desire of PC manufacturers today is to reduce the amount of bundled software. In surveys the reasons cited for this include cost (approx. $20 per system; which is substantial in the low margin, competitive field of hardware sales), lack of quality in the software offerings (so-called “shovelware”), and general customer dissatisfaction. In fact, one top-ten PC manufacturer has found that over 20% of its customer survey respondents sent their PCs back because the bundled software “didn't work.”

Thus, the later purchase of software (i.e., post initial PC sale) remains the overwhelming means by which consumers today obtain software for their PCs. But even this approach has problems which are legend. Obviously there is the awkwardness of a second purchase, or purchases, with the attendant issues of what is now current, where it is in stock, and whether the stores are open. There are also heightened compatibility problems, since the consumer is now back in the store and the PC is now at home or in the office. And there are customer service issues. Even if the consumer returns to the very same store where he or she bought the PC, and perhaps even the very same clerk, he or she is now treated as if the present software purchase is the total extent of the commercial relationship.

However, as noted above, there are emerging new trends in marketing itself. Computer software is one of the leading commodities which has become digital content. For example, less than 2% of all software sales were recorded in electronic distribution channels in 1996, but that figure has already increased rapidly.

Unfortunately, today electronic distribution of computer software remains merely another form of “later purchase” of software. It does nothing about, and in some cases even exacerbates, the existing technical issues of installation, configuration, and compatibility. And it introduces a plethora of new commercial issues, such as consumer trust in the mechanisms used for transactions, protections for the intellectual property in manufacturer's software products, and legal mechanisms to address breakdowns in these.

The above discussion has primarily used PCs as an example, but the problems extend beyond PCs. Many existing, and particularly emerging, personal computerized devices also suffer from these problems. A few present examples are gaming stations, like Sony's latest Playstation (TM) and Microsoft's X-box (TM); personal communication service (PCS) devices, generally; television “set-top” boxes that permit access to the Internet, such as WebTV (TM); Internet access enabled cellular telephones; and particularly personal digital assistants (PDAs). Furthermore, we are seeing a merging of device functionality. For example, some lap-top PCs today have built in digital image collection devices that can capture still and moving pictures. PCSs and PDAs will probably contain such next, and this will blur and probably eventually eliminate the need for digital cameras and “cams” (digital movie cameras) to be distinct devices. Thus, we are approaching a point where we may not need to own many different devices, but just one or two “personal devices” that we use for text, audio, image, etc. data types and for the capture, storage, playback, communication, etc. of this data.

These existing and expected examples have one thing in common, a primary storage unit where an operating infrastructure, applications, and various forms of data are stored. From a hardware perspective, primary storage typically is non-volatile storage which is usually fixed in place for a relatively long period time and often, but not necessarily, can be rewritten. This definition includes conventional hard drives, which historically have been fixed in a computerized system but which increasingly may be mounted in cartridges and removed, even being “hot-swappable” in some cases. Hard drives have, in recent history, been provided in 5¼″ and 3½″ sizes, and in a less widely accepted 2″ size. For the sake of this discussion, hard drives are magnetic storage drives of 2″ form factor or larger. Micro-drives are also magnetic storage drives, but smaller than the 2″ form factor, particularly being thinner than hard drives. Another class of primary storage is flash memory units, typically called “flash cards.”

Looking at the problems of concern here from a higher-level perspective, an overriding problem is getting what we “want” into primary storage. Such primary storage usually comes with what we “need,” a minimal operating system and maybe some basic utility-like applications, but if one wants anything more it has to be sought out and obtained, then loaded or installed, and possibly configured and tested.

Accordingly, from the above it follows that what is today needed is a new mechanism for the marketing of computer software and services, one provides us with what we want, when and how we want it. And to facilitate such new marketing mechanisms, what is also needed today is a local portal.

### DISCLOSURE OF INVENTION

Accordingly, it is an object of the present invention to provide a mechanism for the marketing of digital content via a persistent desktop object (PDO) on a display of a personal computerized system.

Another object of the invention is to provide a mechanism for such marketing of digital content which provides a local portal for presenting digital content on a display of a personal computerized system.

And another object of the invention is to provide a such mechanism for the marketing of digital content which can procure additional, non-local digital content.

Briefly, one preferred embodiment of the present invention is a local portal system including a personal computerized system having a display and a primary storage unit. The primary storage unit is provided with an inventory of local digital content which has been installed before its being received by a user. Logics then operate a persistent desktop object (PDO) which is perceivable on the display by the user and present a presentation of digital content with the persistent desktop object which initially includes at least part of said local digital content.

An advantage of the present invention is that it provides a marketing mechanism which may utilize a persistent desktop object (PDO) in a local portal providing user access to digital content.

Another advantage of the invention is that it may flexibly deliver the digital content which it is providing a user access to. It may stream delivery of local or non-local digital content, if an available communications link permits. It may alternately buffer incoming non-local digital content until a complete unit is available locally for smooth presentation. Or it may alternately receive non-local digital content and store it locally as local digital content for selective later presentation.

And another advantage of the invention is that it may work with user profiles and permit targeting classes or specific digital content to the user. Furthermore, the invention permits choice of the digital content for such targeting to performed locally, in the personal computerized system, or remotely in a remote computer system from which the non-local digital content will be obtained.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF THE DRAWINGS

The purposes and advantages of the present invention will be apparent from the following detailed description in conjunction with the appended drawings in which:

FIGS. 1a-b are basic stylized depictions of how an embodiment of the invention may reside in a users personal computer;

FIGS. 2a-b are basic stylized depictions of a business model which may be used by the invention;

FIG. 3 is a detailed block diagram of one suitable architecture for the invention;

FIG. 4 is a block diagram depicting one functional overview of the invention;

FIG. 5 is a block diagram depicting one navigational overview of portions of the invention which may reside in a client computer system;

FIG. 6 is a depiction of a top view, or “village” view, presented by a graphical user interface (GUI) suitable for use on the client computer system of FIG. 5;

FIG. 7 shows a store GUI view, accessible via the GUI in FIG. 6;

FIG. 8 shows an asset GUI view, accessible via the store view in FIG. 7;

FIG. 9 shows a purchase summary and confirmation GUI view, i.e., a “check-out” view, accessible via either the store view in FIG. 7 or the asset view in FIG. 8;

FIGS. 10a-e show a search GUI views accessible via the GUI views in FIGS. 6-8, where FIG. 10a depicts an asset name based search, FIG. 10b depicts a provider name based search, FIG. 10c depicts the search of FIG. 10b expanded to include particular assets from a specific provider, FIG. 10d depicts a category based search, and FIG. 10e depicts an overview search based on a village map metaphor;

FIG. 11 is a block diagram depicting a hierarchical overview of an implementation of a master server application using access via the Internet;

FIGS. 12a-c depict how the DCVM can implemented as an N-tier configuration grouped by function and location, with FIG. 12a showing a block diagram overview of major tier elements, FIG. 12b showing a block diagram of a more detailed architecture topology overview, and FIG. 12c showing a block diagram of a server oriented overview;

FIG. 13 is a block diagram which particularly depicts the first and second tiers of the client in the embodiment of the DCVM of FIGS. 12a-c;

FIG. 14 is a block diagram illustrating agents and applets in the client and the transaction server, and particularly includes an architecture for the server transaction agent;

FIG. 15 is a block diagram of more detail in the transaction server of FIG. 14;

FIG. 16 is a schematic diagram depicting one screen layout (somewhat different than those depicted in the embodiment of the DCVM represented in FIGS. 6-10e) which the client may represent;

FIG. 17 is a block diagram showing where the DCVM can fit into an ADFORCE database and data broker scheme; and

FIG. 18 is block diagram showing one possible click stream data flow approach which the DCVM may use.

Table 1 shows a suitable file format for the clickstream data;

Table 2 shows a sample click report file generated from test data and then translated using such a ClickReportReader JAVA class; and

Table 3 shows representative classes and methods permitting extraction of data directly from the serialized clickstream files.

### BEST MODE FOR CARRYING OUT THE INVENTION

A preferred embodiment of the present invention may be practiced in a digital content vending “machine” (“DCVM”). As illustrated in the various drawings herein, a form of this preferred embodiment of the inventive device is depicted by the general reference character 10.

The DCVM 10 may be advantageously viewed using two analogies. The first of these, which is alluded to by its label, is the vending machine. This analogy serves well for providing a general overview of the invention as a system for vending digital content. The second analogy is the village square, which the inventors use for the graphical user interface (GUI) of the invention's preferred embodiment. This village square analogy serves particularly well for giving users an easily grasped and usable perception of the invention as a system for purchasing digital content.

A conventional vending machine, such as a coffee machine, for example, will sell its primary commodity (coffee), but then often also sell parallel market items, like tea and soup, and dispense optional items, like cream and sugar. Similarly, the DCVM 10 sells digital products as its primary commodity, but it also may sell related information and services for such, and also dispense customer support and access to communications with like minded consumers. Thus, the DCVM 10 provides both digital products and digital services, i.e., digital content.

The DCVM 10 may be implemented to resemble a conventional town center or village square (i.e., a commercial hub, similar to a shopping mall today). In such a real place there will typically be shops or stores catering to different tastes, income levels, professions, ages, etc. There will be stores that provide primarily goods, and others that provide primarily services. There typically will also be diverting entertainments, and areas set aside simply for communications with those sharing similar interests. And there usually will also be directory plaques or information kiosks to help users find where things are at and to assist in getting to them. As products and services increasingly become digital, this village square analogy is readily extendable into the DCVM 10 as now described.

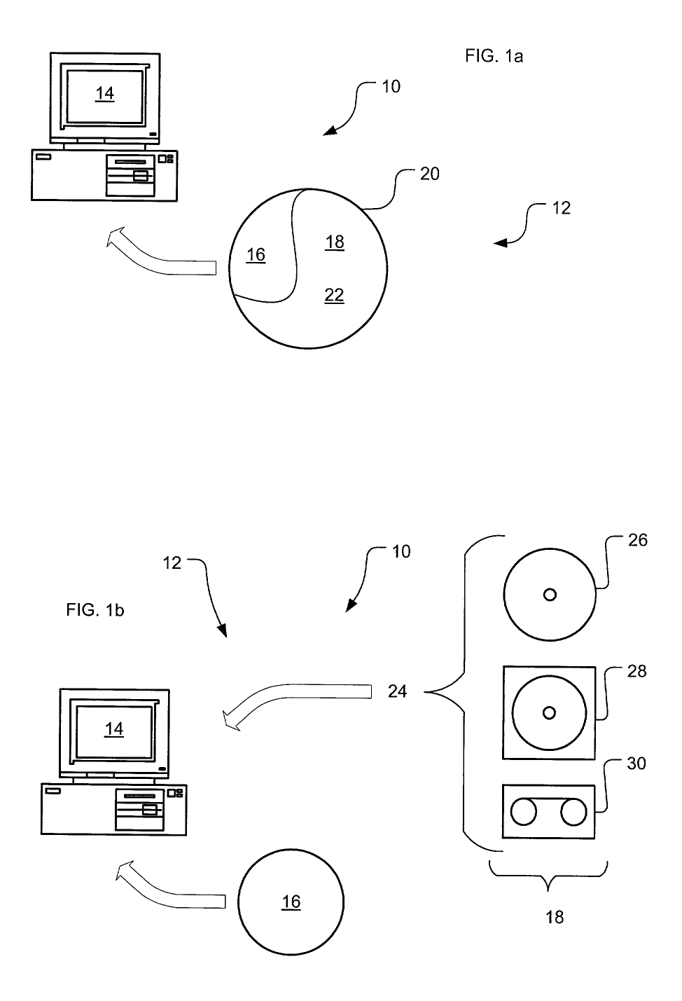

FIGS. 1a-b present how the client 12, i.e. a client application, resides on a user's personal computer (PC 14) and contains both an infrastructure 16 and an inventory 18. The infrastructure 16 is an engine that handles the functionality of the DCVM 10, and the inventory 18 is the local collection of assets 22 of merchandise or units of service.

The infrastructure 16 is relatively static. Like most software applications, it perhaps merits an occasional upgrade as new features become available, but otherwise may be generally installed and left alone. It is anticipated that the infrastructure 16 will usually be stored on a local hard drive 20, although in some case a hard drive 20 on a local area network (LAN; not shown) may also be acceptable. Keeping the infrastructure 16 local insures good overall DCVM 10 responsiveness.

In contrast, the inventory 18 is relatively dynamic, potentially including assets 22 such as computer software products, music, audio books, video, and anything else which can be reduced to digital format and electronically transmitted and stored. The inventory 18 may be loaded on a local device, or it may also be accessible over a LAN having an appropriate bandwidth, since storage capacity and transfer rate are more important than responsiveness for it.

In FIG. 1a both the infrastructure 16 and the inventory 18 are depicted residing together in fixed storage in the PC 14. Today such fixed storage will typically be hard drives 20 (also sometimes termed a “fixed drive”), but as other large capacity storage means become common they may be used instead.

FIG. 1b depicts how the infrastructure 16 may reside in fixed storage, but the inventory 18 instead reside in a removable media 24 which is accessible by the PC 14. Some common current examples of such removable media 24 are CD 26, DVD 28, and tape 30, but still others are easily possible.

In basic embodiments of the DCVM 10 which are delivered by hard drive 20, approximately one to four gigabytes of storage are used. Of this the infrastructure 16 is roughly 50-100 megabytes in size and the inventory 18 takes up the balance. For embodiments delivered by CD 26, only about 600 megabytes are used for the inventory 18. However, as larger capacity hard drives 20 and higher capacity removable media, like DVDs 28, become widely available the infrastructure 16 and particularly the inventory 18 may be made larger, as desired.

In one preferred embodiment, initial delivery of the infrastructure 16 is on the hard drives 20 of new PCs 14. However, the DCVM 10 may also be “delivered” on a new hard drive 20 used for upgrading an existing PC 14. Or it may even be delivered via conventional software installation by loading it from removable media 24 into the PC 14, or by downloading it from an online source and then installing it (a newer installation technique becoming common today). Initial delivery of the inventory 18 may similarly be in pre-loaded format on the hard drive 20, or by provision on removable media 24 which is then placed as needed into the PC 14 for access by the infrastructure 16 (typically depending upon the capacity of the hard drive 20).

Of course, like in real world stores, the inventory 18 of the DCVM 10 needs to be replenished as sales occur, updated as new versions become available, and expanded as suppliers change and new offerings become available. Therefore, the DCVM 10 may be maintained and updated using intelligent push technology over modem networks, like the Internet. Such push technology (e.g., technology compatible with ACTIVE DESKTOP, TM Microsoft Corporation, and NETCASTER, TM Netscape Corporation) may also be used to provide a one-to-one buying and selling experience for users, and to allow individual preferences to be collected and catered to without need of human intervention.

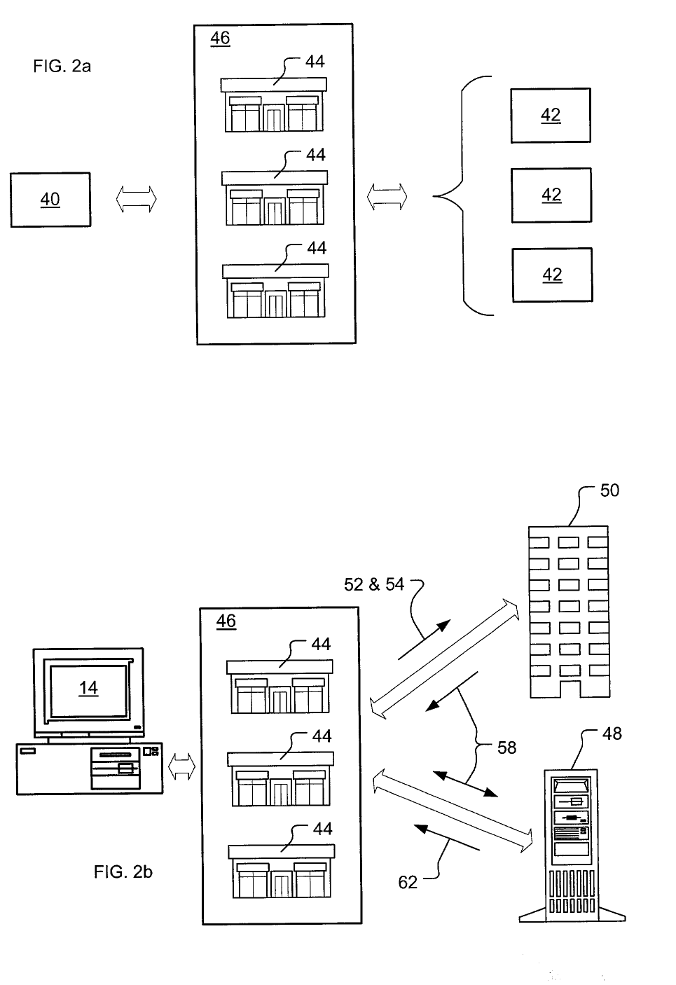

FIG. 2a depicts, in simplified form, a business model which may be used by the inventive DCVM 10. The end users are termed customers 40 and those entities providing the digital content are termed vendors 42. The vendors 42 operate stores 44 (a term used broadly to denote a point of supply for any digital content, regardless of whether overtly commercial in nature). A graphical user interface (GUI), termed the village 46, is used to present collection of the stores 44 as a virtual setting in which the vendors 42 vend and the customers 40 consume. The stores 44 in the village 46 advertise and carry out commerce at various levels of directness, and particularly through several audio and visual channels in each. It is expected that each store 44 typically will feature three main activities: shopping for digital content, viewing events, and communicating.

FIG. 2b depicts a more complete version of the business model introduced above. In addition to their local presence, the vendors 42 are also collectively represented on a master server 48, and all can invoke the assistance of a financial intermediary termed a clearing house 50. The clearing house 50 facilitates complex purchase scenarios, permits larger numbers of stores 44, and more dynamically provides service to both the customers 40 and the vendors 42.

In a typical example purchase scenario, a customer 40 transmits money 52 and an identifier 54 to the clearing house 50. The clearing house 50 then credits the account of the particular vendor 42, and transmits back to the customer 40 a key 58. Next, usually automatically under control of the infrastructure 16, the customer 40 sends this key 58, or part of it, on to the master server 48, which sends back another key 58 (the keys 58 are typically all unique). Again automatically, if desired, the infrastructure 16 uses this second key 58 to digitally “unwrap” an asset 22 of inventory 18, which has now been “purchased.” Since the money 52, identifier 54, and the keys 58 can all be relatively small, compared to the asset 22 being purchased (typically many megabytes in size), even transactions in very sizable digital content can be carried out quite quickly.

Of course, simpler purchase scenarios are possible. The customer 40 might deal directly and entirely with the master server 48. However, at least for the near future, there is no reason to expect that customers 40 and vendors 42 will feel secure without some “online” commercial intermediary such as the clearing house 50. Alternately, if the asset 22 is already part of the inventory 18, and if the vendor 42 completely trusts the clearing house 50, and if the clearing house 50 is willing to carry appropriate keys 58, the key 58 sent back from the clearing house 50 may be made suitable for directly digitally unwrapping the asset 22. However, since some communications already must take place anyway, and since that will often already be occurring over a medium such as the Internet, there is relatively little burden added by the customer 40 to master server 48 communication legs to the transaction.

The keys 58 play an important security role. They unlock a digital wrapper 60 (not shown, since it is not directly tangible; but numbered here for reference) protecting the asset 22 once it has been paid for. In most cases the vendors 42 will strongly want such protection, to suppress unauthorized copying of their intellectual property. The digital wrapper 60 may use simple serial number entry to enable or disable a reminder feature, or it may use soft or hard encryption (both conventional concepts). Alternately, the digital wrapper 60 may use what the inventors term a “two sector steal.”

In the two sector steal, embodiments of the inventive DCVM 10 that store the inventory 18 on a hard drive 20 have two disk sectors of information (an amount empirically found preferable by the inventors) initially omitted. Upon asset 22 purchase, data in the appropriate “stolen” sectors can be supplied, either as part of a key 58 itself, or via use of a key 58 to unlock sector data which has been present all along in an encrypted format. In this manner the asset 22 remains unusable until the missing parts are supplied, yet can be unwrapped reasonably quickly, particularly if the key is electronically communicated to the PC 14.

The two sector steal provides particular advantages to OEM suppliers of PCs 14 and upgrade hard drives 20. The assets 22 can be supplied entirely pre-installed and default configured, but with the sectors stolen (note that sector stealing eliminates the need for bulk encryption). When such an asset 22 is then purchased the sectors are merely installed (or in place decrypted) and the asset 22 is immediately and assuredly ready for use, which will eliminate many technical support calls to the OEM suppliers. And when the customers 40 do have to seek help, the issue of who is to blame for the problem is substantially reduced, which greatly increases their willingness to pay for support and still hold the supplier in high regard.

For additional security, in addition even to the use of keys 58, at the option of the vendor 42 (perhaps under a contractual obligation with the actual software publisher), assets 22 may be “machine bound” to a limited number of physical hard drives 20. For example, as discussed further below, even verbal delivery of keys 58 to customers 40 via the telephone can be used by the DCVM 10. Such keys 58 obviously must be manageable in size and directly enter able by the customers 40, yet it is highly desirable by the vendors 42 that the customers 40 not be able to use one key 58 to unwrap more than one copy of an asset 22. This is easily provided for if the keys 58 are each specifically related to some relatively unique indicia on the hard drives 20. A Help/About menu access in the village 46 can provide a short code based upon such a unique indicia, and a customer 40 can then enter the code with a telephone touch-tone pad to receive a key 58 which only unwraps an instance of the particular asset 22 on their hard drive 20. In this manner, each asset 22 purchased from the DCVM 10 may be restricted from even highly skilled and determined efforts at unauthorized use.

The keys 58 may also play an important commercial role, facilitating payment and accountability of all parties involved. They may act as customer 40 receipts for payment, and vendor 42 vouchers for payment. Assuming that unique keys 58 are used and are retired after one complete transactional cycle, if the a key 58 is ever lost it can simply be reissued, since it will only work once and then only for its intended purpose. As noted above, the use of a second key 58 is optional, but much can be gained by doing so. This permits the vendor 42 to closely track its market, and, more importantly, keeping the vendor 42 in the “loop” permits better customer 40 support. For example, say that a customer 40 starts a purchase scenario for an asset 22 which is in the local inventory 18 in version 4.10, but the master server 48 now has a newer version 4.15 of that asset 22 in stock. Rather than simply return a key for version 4.10, an offer can be communicated to the customer 40 to (1) go ahead and send the key 58 for version 4.10, or (2) transmit version 4.15 of the asset 22 to update the local inventory 18 and also send the key 58 which will unwrap it, or (3) cancel the transaction (perhaps to be resumed after the customer is mailed a CD 26 containing an updated inventory 18).

The master server 48 can also take an active role in maintaining the infrastructure 16 and the inventory 18, by sending updates 62 to the PC 14 containing fixes and enhancements of the infrastructure 16 and new assets 22 for the local inventory 18. By using the master server 48 as a collector of preferences of the customer 40 to selective apply such updates 62, the inventory 18 can be particularly tailored to the preferences and statistical purchase history of the customer 40.

To assist the master server 48 in this role, click (and key stroke) streams for the customer 40 can be tracked on the client 12 running on the PC 14. This with to a substantially unique indicia for the client 12 can then be used with Internet push technology for determining and transmitting appropriately tailored updates 62, or at least prioritizing such updates 62. The indicia used may be a code pre-stored in a hard drive 20 or a removable media 24, or it may be generated on the first execution of the client 12, or it may be provided as a registration process on the master server 48.

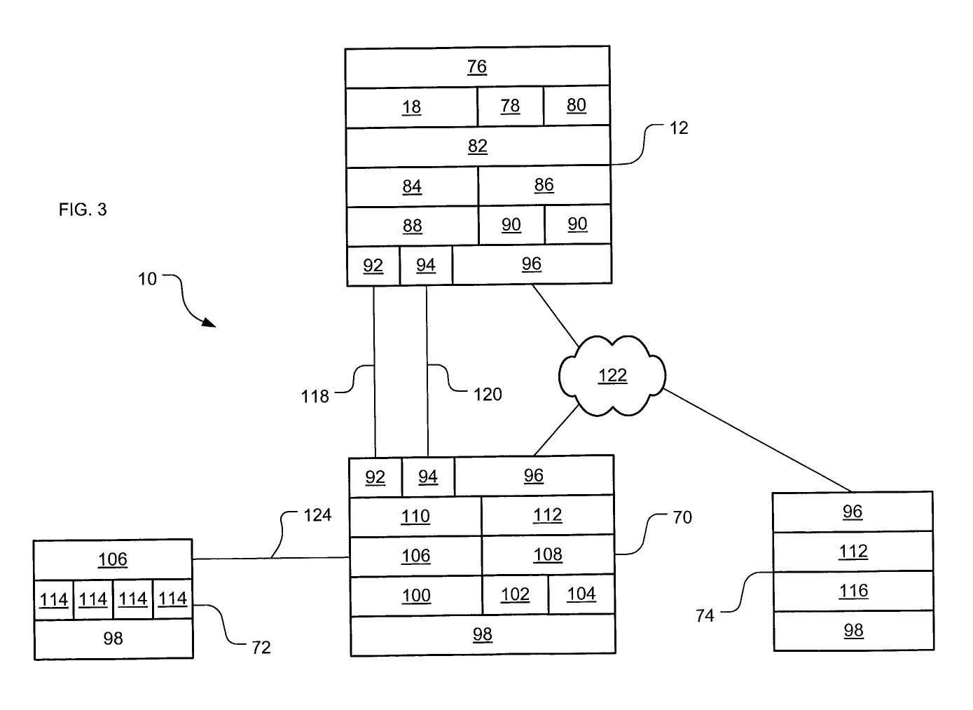

FIG. 3 depicts a suitable architecture for implementing a full featured embodiment of the inventive DCVM 10. The client 12 runs on the PC 14 of the customer 40, a master application 70 runs on the master server 48, a clearing house application 72 runs on the clearing house 50, and a streaming media service 74 is provided.

The client 12 resides on the PC 14 in a layered structure. The lowest layer (hardware and BIOS layers in the PC 14 are not shown, but may be entirely conventional) is a suitable operating system (a client OS 76; e.g., WINDOWS 95, WINDOWS 98, WINDOWS ME, WIDOWS NT, or WINDOWS 2000, TM Microsoft Corporation of Redmond, Wash.). The next layer includes the inventory 18, a village profile 78, and a preference log 80. Atop this is a layer formed by a village manager 82, which using the village profile 78 and preference log 80 permits tailoring for particular customer 40 needs and preferences. At a higher layer are a village interface 84 and an update sub-client 86. Since the village interface 84 itself needs updating from time to time, the update sub-client 86 needs to preferably be in at least as high a layer. Atop this is a layer that includes an order entry interface 88, and client protocols 90 (e.g., Marimba, BACKWEB, and/or Intervu tuners for use with the Internet) for communications. Finally, within the client 12, is a communications layer which includes a telephone module 92, a private network module 94, and an Internet module 96 for respectively accessing these mediums of communication.

The master application 70 similarly resides in a layered structure on the master server 48. The lowest layer (again hardware and BIOS layers are not shown) is a suitable operating system (a server OS 98; e.g., WINDOWS NT or WINDOWS 2000, TM Microsoft Corporation of Redmond, Wash.). Atop this are a master interface 100; a profile database 102, from which portions transmitted to a client 12 become stores 44; and a master inventory 104, from which portions transmitted to a client 12 become assets 22 in the inventory 18. The next layer includes a financial peer 106 (discussed further presently) and an update sub-server 108. Atop this is a layer including an order interface 110 and server protocols 112 (e.g., a Marimba or BACKWEB transmitter for use with the Internet). Finally, within the master application 70, is a communications layer which includes a telephone module 92, a private network module 94, and an Internet module 96.

The clearing house application 72 is run by the clearing house 50, and thus effectively is also a server. It also has as a lowest layer a suitable operating system (another server OS 98). Atop this are financial modules 114, which handle services like anti-fraud, pre-authorization, reporting, etc. And atop this is a financial peer 106, for communicating directly with the equivalent in the master application 70.

The streaming media service 74 has a suitable server OS 98 which supports an audio-visual database 116, atop that are server protocols 112 (e.g., an Intervu transmitter for use with the Internet) and also an Internet module 96.

The client 12 communicates with the master application 70 via either telephone 118 (touch-tone entry or using voice recognition, and pre-recorded or generated message replies), a private network 120, or the Internet 122. Notably, the first two of these reach customers 40 who are not yet on the Internet 122.

If a telephone 118 is used (say to an 800 number), the customer 40 may manually enter credit card information on the tone pad, and then hear recited back a simple key 58 which is used to unwrap the asset 22 purchased (of course, this could also be a conventional verbal human transaction, but such are inefficient). The key 58 may be entered by the customer 40 at the PC 14 either as it is received, or it may be written down and used later when the customer 40 is off the telephone 118. If a private network 120 is used, the infrastructure 16 may alternately automatically unlock the purchased asset 22, the customer 40 may still note the key 58 (presumably a simpler one) for later manual entry. If the Internet 122 is used, the infrastructure 16 may automatically use the key 58 to unwrap the asset 22 now purchased, and the key can accordingly be larger and more complex. It should also be appreciated that groups of customers 40 anywhere on a local network can also use the private network 120 and the Internet 122 variations.

In FIG. 3 the master application 70 and the clearing house application 72 are depicted as connected via a dedicated link 124, i.e., all commercial transactions go physically through the master server 48, but with minimal involvement of the master application 70 itself. This provides for universal access by the client 12 via the master application 70, even over the telephone 118 or private network 120. This also provides for very high security, but that may be dispensed with as alternate security means and confidence in them become widespread, perhaps soon with more secured communication over the Internet 122.

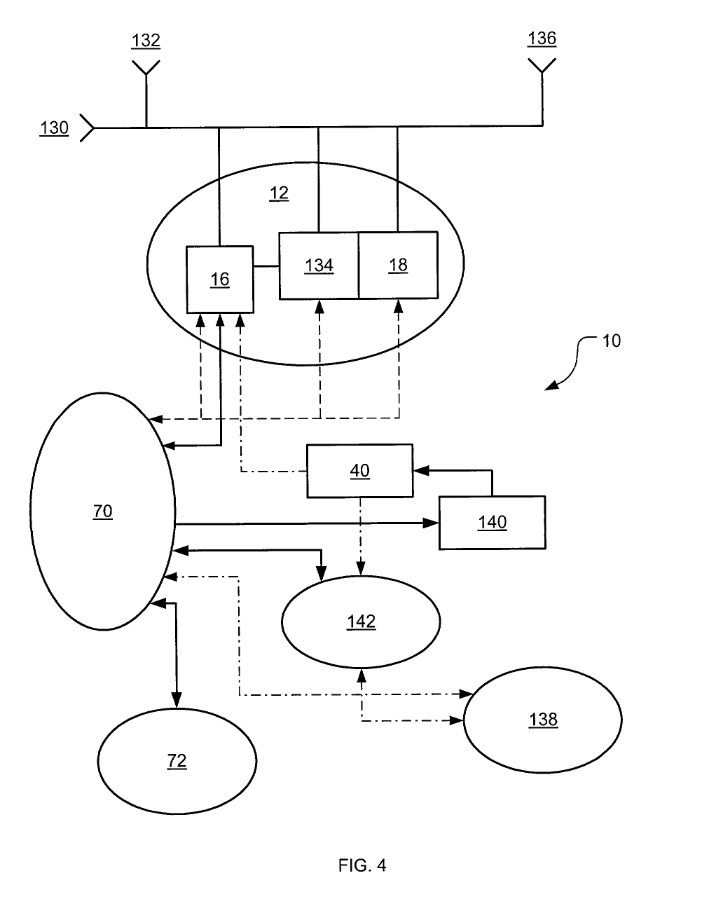

FIG. 4 is a block diagram depicting a functional overview of the inventive DCVM 10. The client 12 is typically installed onto the hard drive 20 of a PC 14 by either an original equipment manufacturer (OEM) (step 130) or loaded by a potential customer 40 (step 132) from a removable media 24, such as a CD 26. The client 12 then contains the infrastructure 16, which provides the GUI of the village 46 to the customer 40, and which is the engine that presents the stores 44 and accesses an inventory database 134 and the inventory 18 itself (either on the hard drive 20 or still on the removable media 24).

As an aside, the impression may have been conveyed that the stores 44 always reside on the hard drive 20 as part of the infrastructure 16. However, while often desirable, this need not always be the case. Since the DCVM 10 permits addition and deletion of stores 44, and since large number of stores 44 may be provided, general access to particularized sub-sets of the inventory 18 may be accomplished by putting only popular stores 44 onto the hard drive 20, and leaving the rest on the removable media 24. Further, as the customer 40 deletes some stores 44 and as the village 46 accumulates actual usage information, the stores 44 actually on the hard drive 20 can be changed.

For local updating of the client 12 after installation, particularly for updating the sizable inventory database 134 and the inventory 18 (say if it is stored on a hard drive 20), additional removable media 24, such as CDs 26 or DVDs 28, may later have their contents copied into the PC 14 (step 136). However, this can be reduced considerably, or even eliminated, if a suitable communications means is available.

Once the client 12 is installed, communications with the master application 70 can ensue, directly from the customer 40 through the infrastructure 16 and indirectly from the inventory database 134 and the inventory 18 (as depicted in FIG. 4 in uniformly dashed lines). The master application 70 and the clearing house application 72 are also depicted as being able to directly communicate. Further, communications from technical support 138 can pass through the master application 70 to and from the client 12. Since a large percentage of PCs 14 on which the DCVM 10 will be loaded will employ step 130 (OEM loading), it is particularly anticipated that this will facilitate access to OEM supplied technical support 138.

The customer 40 can also request fulfillment of orders for hard goods 140 via the client 12. Such hard goods 140 may be ancillary to the inventory 18, e.g., manuals for computer software assets 22 in the inventory 18, or they may be entirely separate, i.e., permitting the DCVM 10 to optionally be used as a catalog server for entirely non-digital content as well.

However, the customer 40 is not restricted to only communicating via the client 12 to the master application 70. The customer 40 may still use a simple telephone, say, using a toll free number, to verbally communicate with phone support 142, and via the phone support 142 to also access the technical support 138 (depicted in FIG. 4 in non-uniformly dashed lines). This particularly facilitates the customer 40 being able to get assistance when the client 12 is “broken” and to advise that something has gone awry in the master application 70.

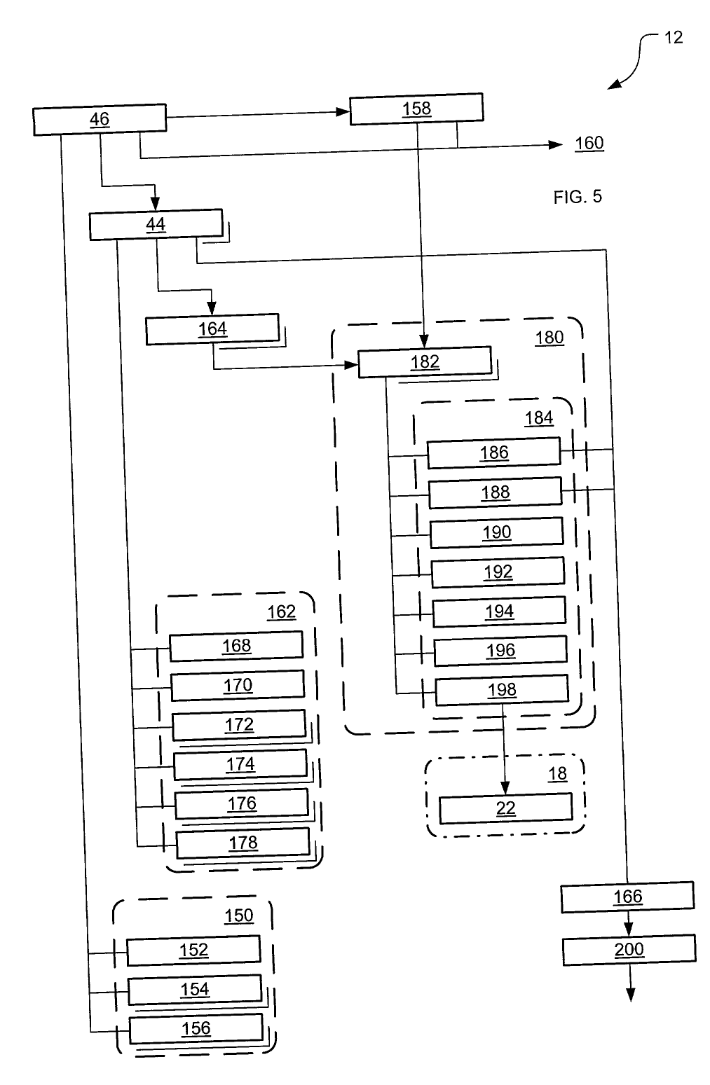

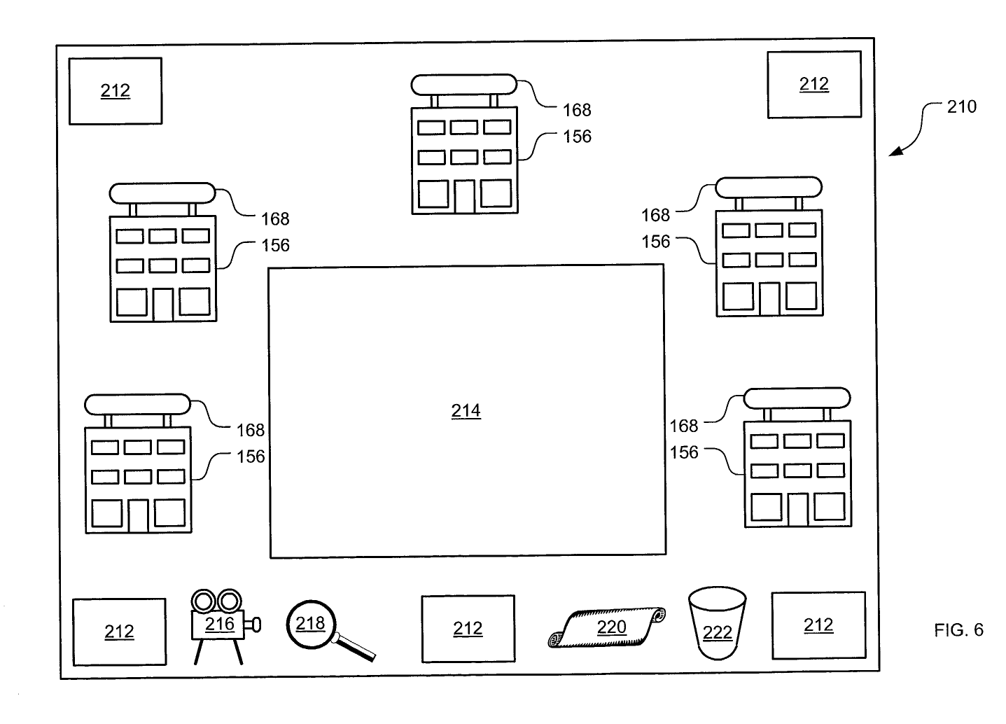

FIG. 5 is a block diagram depicting a navigational overview of one embodiment of the client 12. At the highest level is the village 46, which has a village template 150 including a village video 152, village ads 154, and a number of store controls 156 (combination button-icons). From the village 46 access is also available to a search feature 158, which provides a quick way to find particular assets 22 (described below), and to an extra assets feature 160 which provides access to digital content not presently in the inventory 18 (i.e., in the master inventory 104 on the master server 48). From the search feature 158 there is also access to this extra assets feature 160.

The store controls 156 of the village 46 provide access to the stores 44. Each store 44 has a store template 162, aisles 164, and a shopping cart 166. The store template 162 includes store data 168 (e.g., name, etc.); a store video 170, describing the store 44; and store ads 172, analogous to traditional end-cap advertisements; optional Internet links 174 for the store 44, i.e., for alternately reaching the sponsoring vendor 42; optional promotional ads 176, for particular assets 22, i.e., “hot deals”; and aisle controls 178.

The aisle controls 178 provide access to the aisles 164, usually with a plurality appearing for each store 44. Each aisle 164 has an associated aisle template 180.

The aisle templates 180 each include a number of asset controls 182, each in turn associated with an asset template 184. An asset template 184 includes asset data 186 (e.g., name, provider, category, version, etc.), an asset price 188, an asset description 190, an asset video 192, an asset ad 194, a third-party opinion 196 (i.e., a review of the asset 22), and an asset link 198 pointing to where the particular asset 22 is stored in the inventory 18.

By customer 40 selection when viewing an asset template 184 appropriate information, such as the asset price 188 and the asset link 198, are sent to the shopping cart 166, a place where information identifying prospective asset 22 purchases accumulates prior to formal purchase. Later, back at the store 44 level, the customer 40 can access the shopping cart 166 and invoke an order module 200 to selectively complete formal purchase of the chosen assets 22 in the shopping cart 166.

FIG. 6 depicts a suitable village view 210 for presentation to the customer 40. A series of ad cells 212 are placed about the village view 210. These may contain either fixed or banner advertisements from the village ads 154. The major features of the village view 210 are the store controls 156, each with respective store data 168 prominently displayed, and a centrally placed video display 214. Further provided, at the bottom of the village view 210, are a video control 216, to start/restart the village video 152 in the video display 214; a search control 218, which invokes features described below; a guarantee control 220, which invokes display in the video display 214 of business information about the parties operating the master application 70, the clearing house application 72, and the respective vendors 42; and a delete village control 222, to entirely eliminate the DCVM 10 from the PC 14.

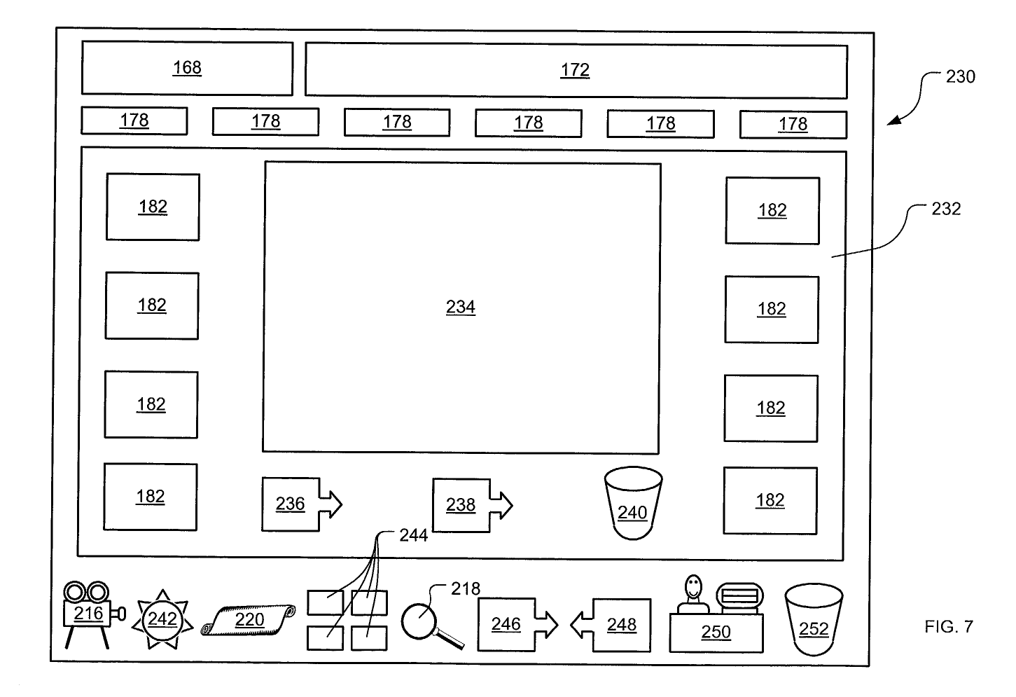

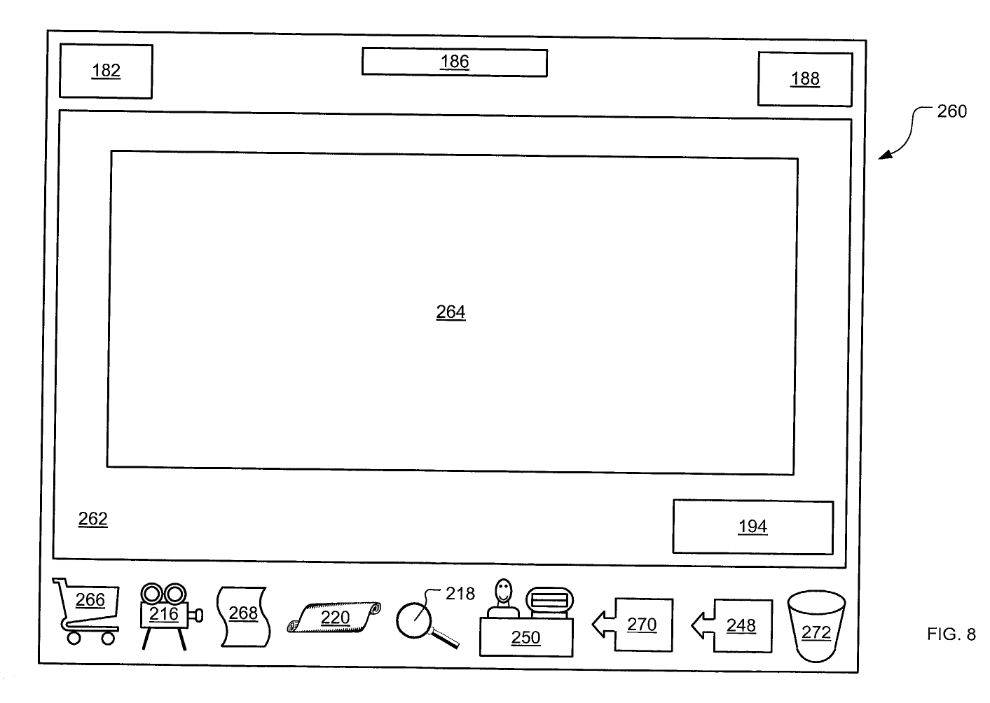

FIG. 7 depicts a suitable store view 230 for presentation to the customer 40. The store data 168 (at least the store name) and the store ad 172 are displayed at the top. Below is a row containing the aisle controls 178. And below that row is an aisle sub-view 232, which changes depending upon which aisle control 178 is currently selected. The aisle sub-view 232 includes a video display 234, asset controls 182, an aisle update control 236, a next page control 238 (to display a subsequent view of assets, since aisles may often contain more than will fit on one view), and a delete aisle control 240. At the bottom of the store view 230 are the video control 216, to here start/restart playback of the store video 170; a promo control 242, to start/restart playback of the promotional ads 176; the guarantee control 220; a links control 244, to display the Internet links 174 for the store 44; the search control 218; an update store control 246; a return to village control 248, to return to the village view 210; a checkout control 250; and a delete store control 252, to remove the present store 44 from the client 12.

FIG. 8 depicts a suitable asset view 260 for presentation to the customer 40. Displayed at the top are the asset control 182 (here acting only as an icon, since it cannot be selected to go to another view), the asset data 186 (at least the asset name), and the asset price 188. Below is an asset sub-view 262 which includes an asset display 264 and the asset ad 194 (typically a banner type ad, which “rotates” continuously).

At the bottom of the asset view 260 are a shopping cart control 266 (to add the present asset to the shopping cart 166), the video control 216, an opinion control 268, the guarantee control 220, the search control 218, the checkout control 250, a return to store control 270, the return to village control 248, and a delete asset control 272.

Depending upon operation by the customer 40, the asset display 264 presents either the asset description 190 (the default), the asset video 192, the third-party opinion 196, or guarantee information.

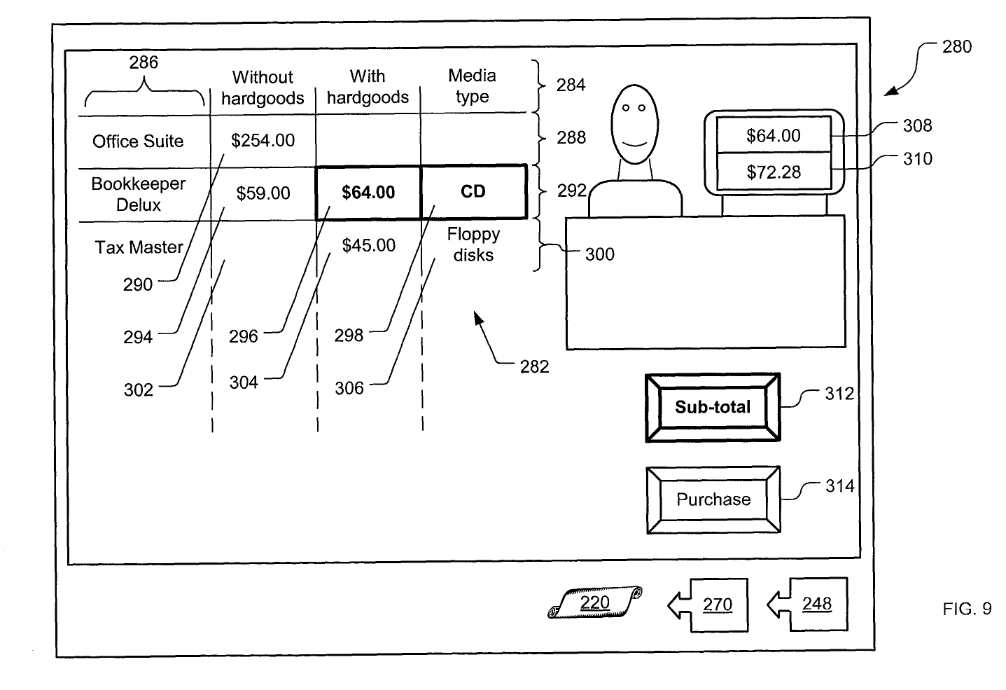

FIG. 9 depicts a suitable checkout view 280 for presentation to the customer 40. Included is an asset table 282 which displays information about all of the assets 22 presently in the shopping cart 166. Across the top of the asset table 282 are column headings 284, indicating availability options, e.g., “without hardgoods,” “with hardgoods,” and “media type.” Along the left side of the asset table 282 are row headings 286 containing respective asset names (from the asset data 186). Depending upon which columns they are in, the cells of the asset table 282 contain asset prices 188 or availability options, and in some cases also function as controls.

For example, assuming the availability options listed above in the asset table 282 presented in FIG. 9, the topmost row 288 contains data only in cell 290 (the leftmost). Further, cell 290 contains an asset price 188 which is not highlighted (in FIG. 9 heavy cell outline designates highlighting). This situation depicts that the asset 22 in row 288 is only available without hardgoods, and that the customer 40 has not yet selected this cell to confirm that they do want to purchase this.

The middle row 292 in this example contains asset prices 188 both in cell 294 and in cell 296, and cell 298 is highlighted and contains text describing a media type. This situation depicts that the asset 22 in row 292 is available both with and without hardgoods, at the respective prices, and that the “with hardgoods” option has already been selected by the customer 40 (as indicated by the highlighting of cell 296 rather than cell 294). The customer 40 here may chose among multiple media types (as indicated by the presence of highlighting in cell 298). Further, since cell 298 is highlighted, the customer 40 may operate it as a control, say with a mouse double-click, to cycle between the available media type choices.

The bottom row 300 in this example contains nothing in cell 302, designating that this asset 22 always comes with hardgoods (say a manual); a price in cell 304 (un-highlighted, and thus as yet un-selected); and un-highlighted text in cell 306. The absence of highlighting for a media type indicates that no choice is available, so the customer 40 should be particularly sure that they can use the media type being noted.

Also appearing in the checkout view 280 are a sub-total box 308, a grand total box 310, a sub-total control 312, and a purchase control 314. The sub-total box 308 displays a running total of the asset prices 188 for selected assets 22 in the asset table 282 (note that only one of the three displayed assets 22 is actually selected in the example, so only its price is used in the sub-total). By activating the sub-total control 312 the customer 40 requests display in the grand total box 310 of the amount in the sub-total box 308 plus applicable shipping costs and taxes (here the sub-total plus 8.25% tax and $3.00 shipping and handling). Activating the purchase control 314 formally requests that purchase take place.

Across the bottom of the checkout view 280 are the guarantee control 220, the return to store control 270, and the return to village control 248.

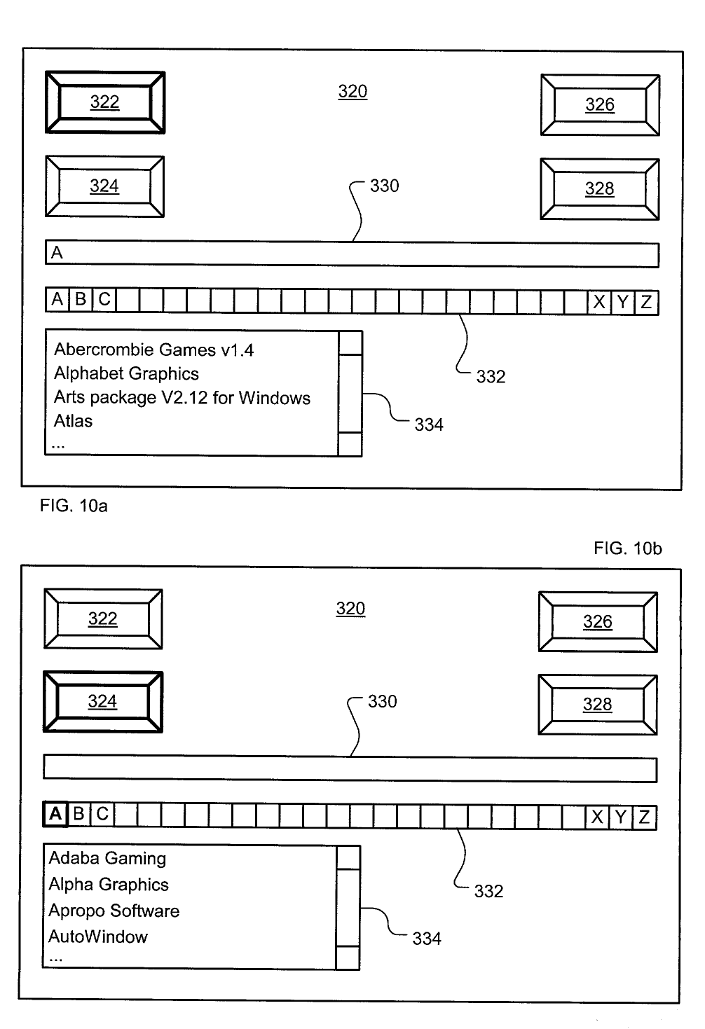

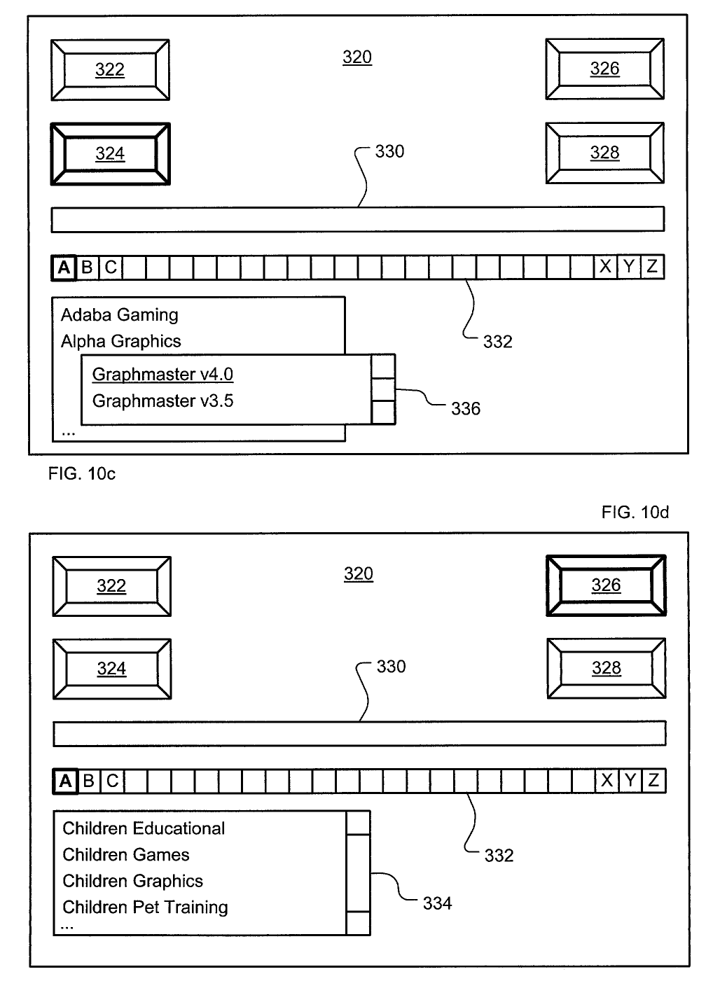

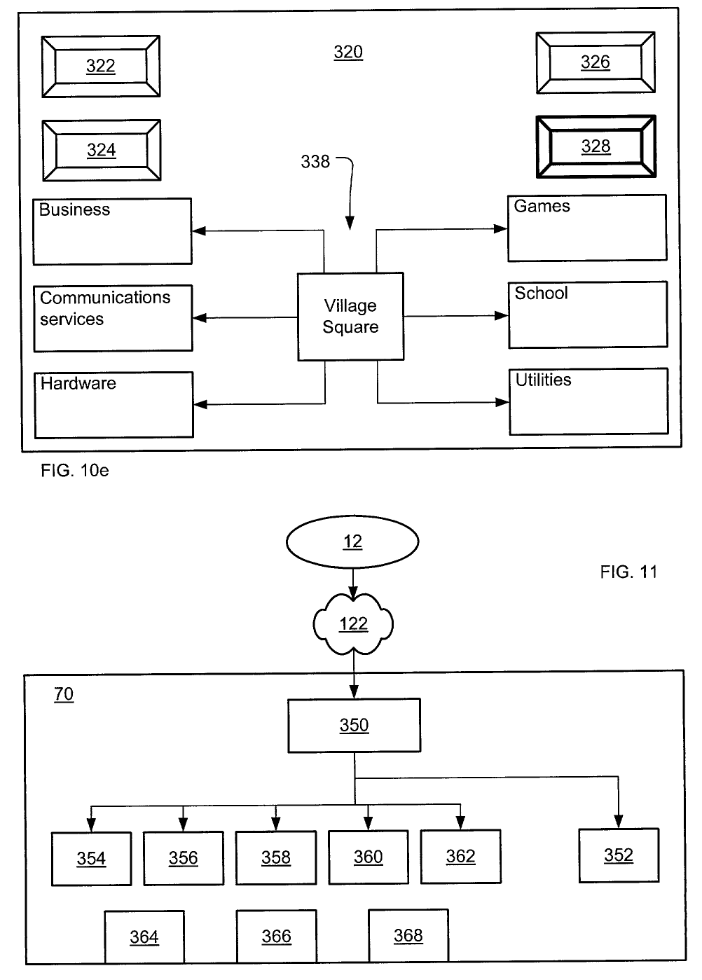

FIGS. 10a-e are stylized depictions of the information presented to the customer 40 when the search control 218 is selected. A search view 320 then appears which includes an asset control 322, a provider control 324, a category control 326, a map control 328, a text entry box 330, a character selection array 332, and a list box 334. In some cases the list box 334 can further include a sub-list 336 (FIG. 10c), and in one case the text entry box 330, the character selection array 332, and the list box 334 may all be replaced with a map sub-view 338 (FIG. 10e).

FIG. 10a shows the default of a search view 320, i.e., a view first seen by the customer 40. The asset control 322 is highlighted (shown with a heavy lining in the figure) to confirm to the customer 40 that the asset based variation of the search view 320 is currently active. The customer 40 may select a provider control 324, a category control 326, or a map control 328 to use other variations of the search view 320. Or, if they have already done so, selecting the asset control 322 will return them to the variation of FIG. 10a.

In the asset based search view 320 of FIG. 10a, the customer 40 may either type initial letters of the asset name (as it appears in the asset data 186) into the text entry box 330 (as depicted in FIG. 10a), or mouse click a first letter in the character selection array 332. These operations scroll the list box 334, which in this variation displays names for assets 22. Alternately, the customer 40 can directly scroll the list box 334. By appropriate choice, perhaps as a setup option, selection of a particular entry in the list box 334 cause an associated asset 22 to be added to the shopping cart 166, or this can take the customer 40 to the asset view 260, with the selected asset 22 there displayed.

If the customer 40 selects the provider control 324 the search view 320 changes to the variation shown in FIG. 10b. Again letters can be entered in the text entry box 330 or mouse clicking may be used to select a first letter in the character selection array 332 to scroll the list box 334 (the case depicted in FIG. 10b), but now provider names are instead displayed for assets 22 in both the inventory 18 (the names as recorded in the asset data 186) and also the master inventory 104.

FIG. 10c shows how selection of a particular provider name in the list box 334 can then cause further display of a sub-list 336 to show assets 22 available from the selected provider. Highlighting, underlining (used in FIG. 10c), or some other convention may be used to distinguish which assets 22 are present locally in the inventory 18, and which are in the master inventory 104. As discussed for FIG. 10a, above, selection of a particular asset entry can be configured to take the user to the asset view 260 or add the selection to the shopping cart 166.

If the customer 40 selects the category control 326 the search view 320 changes to the variation shown in FIG. 10d. Again letters can be entered in the text entry box 330 or mouse clicking may select a letter in the character selection array 332 (the case depicted in FIG. 10d) to scroll the list box 334, but now it instead displays categories of assets 22 in both the inventory 18 and also the master inventory 104. Selection of a particular entry in the list box 334 presents the sub-list 336, only now containing assets by category, and moving to the asset view 260 or addition to the shopping cart 166 can proceed.

In keeping with the village 46 analogy, a map variation of the search view 320 may also be invoked, by selecting the map control 328. This variation is depicted in FIG. 10e, which has the text entry box 330, the character selection array 332, and the list box 334 all replaced with a map sub-view 338. The map sub-view 338 presents a graphic somewhat resembling a conventional map, but since geographic location need not be represented, what is instead displayed are general categories presented as regions encompassing related sub-categories. Here selecting a category or subcategory takes the customer 40 to an appropriate other view.

In the preferred embodiment, the DCVM 10 is a hybrid application that combines web content (HTML, JAVA, Shockwave, chat streams, etc.) and traditional C++ programming to create a dynamic and engaging shopping environment in the setting of the stores 44 throughout the village 46. The DCVM 10 may employ features such as digital certificates, Active Movie and a content advisor system. The invention is also scalable, making it able to work in most current PC 14 environments. The preferred base hardware platform for the embodiment described so far is a 90 MHz Pentium (TM) microprocessor with 16 MB of RAM, 50 MB of free hard drive space, video capability of 800×600 SVGA and 1 MB VRAM, a 16 bit sound system, a 4X CD-ROM drive, the client OS 76 previously described, an analog or ISDN telephone connection (or Ethernet network connection to a system having one of these), and Internet access software. Access to the Internet 122 is desirable, but optional. In addition to the above mentioned examples, various other modifications and alterations of the inventive DCVM 10 may be made without departing from the invention.

Up to this point discussion has primarily been of the client 12. This has been because the master application 70 may be substantially implemented using conventional client-server and hypertext markup-up language (HTML) techniques. For example, FIG. 11 is a hierarchical overview of an implementation of the master application 70 of the inventive DCVM 10, using access via the Internet 122. The client 12 accesses the master application 70 by connection to a hypothetical site at www.master.com (“master” is used here as a hypothetical site domain name). At an HTML home page 350, registered and non-registered clients 12 can enter here, as well as those accessing entirely other features 352 (although registered clients 12 will more typically go directly to desired lower level services). Alternately, accessing www.master.com/view invokes a browse module 354, so that the customer 40 using a registered client 12 can view extra assets 22 not in the inventory 18 of the client 12; accessing www.master.com/buy invokes a purchase module 356, for customers 40 to directly purchase such non-local assets 22 and/or hard goods 140 from out of the master inventory 104; accessing www.master.com/update invokes an update module 358, to update the inventory 18 in the client 12; www.master.com/comm invokes an issue service module 360, for support for issue resolution and access to frequently asked question (FAQ) lists; and www.master.com/fix invokes a technical update module 362, to obtain bug fixes and updates of the infrastructure 16 in the client 12. Finally, also shown in FIG. 11 are a customer database 364, a log file 366, and a report generator 368, all of which may also be largely conventional in nature.

The DCVM 10 may be implemented as a complete N-tier system that provides computer owners (typically new owners) with a convenient means of browsing, evaluating and purchasing digital content, both while online and while “offline.”

The computer owners, or “customers” are able to peruse an inventory of digital content and information about it in a rich multimedia format, compare a large catalog of the inventory and prices, and then register, purchase, and even upgrade items of the digital content immediately.

The DCVM 10 is a media rich, and convenient consumer shopping experience. Delays are eliminated by pre-positioning all or at least substantial portions of the “store,” its inventory of assets, and collateral marketing materials at the customer's computer system. In particular, this can even be on the hard drives of new computer systems.

As has been described, the user interface the DCVM 10 may be based on the metaphor of a small village, which consists of some number of shops, each of which contains some number of aisles, and each aisle contains some number of digital content items. Recall also that the digital content can include goods and units of service.

The inventory of digital content, advertising, and other information related to the digital content can be updated on a regular basis, both through removable media mailings (e.g., of CD/DVD) and via network based synchronization and “push” techniques (e.g., via the Internet).

A valuable aspect of the DCVM 10 may also be a customer profile, which tracks customer browsing behavior, purchases, and information requests along with what parts of the store are deleted or reconfigured by the customer. By knowing the customer's preferences the most useful information and assistance about the digital content can be provided to the customer.

The DCVM 10 particularly pre-positions advertising and inventory on the consumer's computer system, along with a convenient purchasing capability. This permits a unique business model for use with newly acquired computer systems.

The customers of such a model may include: end users, OEM and system integrators, independent software vendors (ISVs), and advertisers. The end users benefit because, as consumers, they gain high performance and a convenient and compelling shopping experience for both pre-positioned digital content and remote hard-goods (typically, but not necessarily, related to the pre-positioned digital content). The consumer enjoys a focused inventory selection and, for pre-positioned digital content, a highly convenient and nearly instantaneous purchase process regardless of the size of an item. The OEMs and system integrators gain an annuity-style revenue stream by hosting the DCVM 10 on newly built computer systems. The ISVs gain access to significantly increased visibility, particularly during the “peak buy period” for the newly acquired system, with virtually no distribution cost. And the advertisers have a new platform for advertising that has two key values: an upscale directed client base, and detailed data on the end users who see the advertising. The advertiser has a number of options, including a full store presence, banner advertisements, etc. The types of advertisers may include intellectual property providers (IPPs), hardware system and accessory providers, and Internet service providers, among others.

The services provided by such a business model may include: hard goods fulfillment, clearing house services, and direct system provider services. For hard goods fulfillment the DCVM 10 is uniquely positioned to provide a convenient shopping access to hardgoods fulfilled through traditional means (e.g. EDI), contemporaneous with its digital content vending role. The DCVM 10 is also able to provide for necessary commercial clearing house functions, say, by means of a strategic partnership with one or more clearing house providers. As direct system provider services, the DCVM 10 can provide: customer turnkey business solutions for OEMs and system integrators; management of collateral and the digital content inventory (to collect, organize, integrate, package, test, etc.); maintenance of the infrastructure or “stores”; golden master production for loading the media delivery system; collections and billing; as well as be a provider of utilization and advertising demographics data.

The inventor's preferred initial release of the DCVM 10 is targeted at home users and small office/home office (SOHO) users. Small business, corporate and enterprise markets can be additionally targeted with focused features and appropriate methods of communicating in subsequent releases. This preferred initial release is also targeted to client systems running the WINDOWS operating systems (Windows'95, Windows'98, WindowsME, Windows2000, WindowsNT, all TM Microsoft Corporation of Redmond, Wash.), but other operating system can be provided for as well.

The presently preferred DCVM 10 uses a village or “mall” shopping metaphor and a storyboard to group and differentiate information related to the digital content. FIGS. 2a, and 5-9, previously described, generally cover this.

A village 46 can be described as a hierarchy, consisting of a some number of stores 44 plus village common pages. A store 44 consists of some number of aisles 164 and store common pages, with store common pages including one or more pages that augment the store, e.g., a store home page and pages for general store information, specials, etc. The store common pages may also include one or more featured products pages.

An aisle page emulates a store shopping aisle, and typically contains a banner ad which contains an end-cap product display. Additional ads may also be provided, as may an aisle banner, and other links. However, the key content of an aisle 164 is one or more product displays (i.e., offers of digital content assets 22). Such a display may include a “box shot” (or display graphic, i.e., a photo or graphic of the asset 22), a product data sheet, a screen shot (e.g., a static or rotating GIF image), a video, reviews, etc.

Within this village metaphor a user interface provides for: browsing and navigation, search, and purchase. A combination of a browser interface and integrated application can be provided for update control, purchase management, and configuration control. The end user customers can then use a web browser-like application to shop, browse, navigate, and initiate purchase through the DCVM 10 of its contained or associated digital content.

The stores 44 of the DCVM 10 include digital content from two sources: pre-positioned digital content (in the inventory 18 already at the client 12; see e.g., FIG. 1a) and extended or master inventory 104 located in online extensions or a content server (e.g., the master server 48 of FIGS. 2b and 3).

The DCVM 10 may make a compelling presentation, particularly including high performance access to content allowing greater use of high-resolution materials. This particularly facilitates easy navigation to find digital content, easy searching, an application which is browser-based, and seamless continuity with online extensions of the DCVM 10.

“Shopping Cart” and “Checkout” metaphors may be used for both off and on line purchasing. FIGS. 6-9 generally illustrate this. Checkout may be accomplished via an online connection (say, to a Distributed Transaction Server). Alternate purchase options are possible, such as providing human operator supported telephone support, purchase support for standard credit cards, and purchase support for “credits” for “freegoods,” as may be required by partner OEMs.

Softgoods fulfillment may be accomplished by unwrapping (typically including decrypting) pre-positioned intellectual property and by providing means for additional download of intellectual property (and subsequent unwrap/decrypt).

Hardgoods fulfillment may be accomplished via forwarding purchase requests directly to hardgoods fulfillment houses and indirectly through clearing house arrangements for EDI based fulfillment.

A credit card clearing house can provide purchase approval, fraud detection and filtering, tax and shopping charges, international trade regulation compliance, “free” Credits clearing and this can be handled within the backend services of the DCVM 10.

The client based store of the DCVM 10 may be updated through online push channels and through distribution of removable media 24 (FIG. 1b; e.g., CD 26, DVD 28, etc.). Digital content assets 22, collateral materials, look and feel elements (all treatable generally as digital content), as well as the infrastructure engine, are all candidates for update in this manner. Updates to a client 12 may be prioritized based on design specified requirements and user set policy. Prices and easy, small updates typically will be updated most frequently, but permission to update can be set by client policy. Easy transition between “browsing” and “update” modes can also be provided so that users will control and manage updates by policy and by category.

Customers may be provided with a content manager as part of the infrastructure 16, to control and manage aspects of the DCVM 10. The entire village 46 may be removed under user control, for instance, and new stores 44, aisles 164, and digital content assets 22 may be added to the existing local stores 44 in order to expand or to get better performance in a particular area, or removed in order to reclaim storage space at the client 12.

The customers may therefore set Policy for actions in various areas. For example, they may update policy, e.g., specify to always warn, ask, or never warn. They may set connection policy, e.g., to anytime/automatic, ask, never. They may define privacy policy, e.g., to tell all, to say nothing, or somewhere in between.

Customer and OEM unit identification can be established and maintained through on-line, voice, and mail registration. The customers can be encouraged to provide additional profiling information through awards and granted digital certificates. Award and “freebie” activities can also be coordinated with the individual OEMs. Customer activity in the stores 44 can be tracked, and uploaded as profile information ultimately to be stored in a customer information server. Of course, a privacy policy can be established and maintained within the conventions of Internet shopping.

Some particularly customizable components can be sponsorship and advertising graphics. In addition, identifying information can be embedded into each OEM associated client 12, such that purchases and activities associated with a particular release of the DCVM 10 can be tracked. (Enabling OEM associated tracking of transactions.)

The DCVM 10 can provide customer service through a variety of outlets, and services. Arrangements can be made with OEMs for direct support of particular OEM's goods. Goods sold through other arrangements, say, with hardgoods manufacturers, can also be supported directly by the manufacturer.

The DCVM 10 can provide direct customer service for order management and fulfillment, payment, first line digital content installation issues and for technical support questions and problems. These services can be provided through a web support site, or by fax or e-mail.

A business model using the DCVM 10 can place significant requirements on central development and MIS core services. But these are manageable, as is now discussed.

Appropriate build management can be used to create multiple master stores 44 for the purposes of OEM duplication and for online use. Each such OEM master is estimated by the inventors at this time to contain between 50 and 200 products (i.e., assets 22), a large number of associated advertisements and collateral, plus the components of the store infrastructure itself. Content build management can be used to efficiently and rapidly rebuild OEM specific stores 44. To this end, content build management may typically use a content inventory database, containing all components for all the stores 44 (online, and masters for pre-positioned stores), and a component management system where stores will be treated as top level assemblies comprised of subassemblies. Suitable integrated assembly tracking systems for this can be purchased or developed.

A profile of each customer can be kept in a customer database. This database can then be used to assist with direct interactions with the customer, to customize online transactions and updates to each customer, to assist with fraud detection, to assist with billing, and to provide marketing and demographic material through data mining techniques.

Intellectual property resident on the clients 12 may particularly be protected, with state of the art encryption techniques. As has been described, the DCVM 10 can include pre-positioned software products and other types of intellectual property assets 22 of considerable value, such may be provided in a protected or limited use form until purchase. May arrangements for this can be made. A “Buy Only” (BO) asset 22 can be made unavailable to an end-user until purchase. Upon purchase, a non-sharable key 58 (FIG. 2b) can be applied to a wrapped “Bag'o Bits” (BOB) to unlock it, and to initiate installation. A “Try Before You Buy” (TBYB) asset 22 can be made available in a form, say, limited by maximum number of tries, maximum time, or maximum duration. Such a TBYB type asset 22 can may be either “wrapped” in a digital wrapper 60, and limited to running in a protected environment, or “injected” with a runtime module that restricts use. A third form of “Try Only” digital content has advertising value, but no direct revenue value, as it is not be purchased.

Thus, all of the assets 22 (BO and TBYB), as well as collateral digital content, if desired, may be protected from theft through the use of industry standard and commercially available encryption and wrapping, and obfuscation techniques.

Customer purchase transactions can be conducted via Secure Sockets Layer (SSL). Customer purchase information can be protected via state of the art firewall techniques. Private purchase and transaction information between distributed techniques can be via state-of-the-art VPN or via private leased lines. Online stores and update servers may be made either “read-only,” “proxies” only, or both. Interaction with outside clearing houses can be through a combination of certified (signed) public/private key links, or through other secure means.

Up to here the discussion has been of client side security, but the backend components of the DCVM 10 can also be well protected. Generally conventional techniques can be used for this, and this discussion will not generally cover such. For example, those skilled in the art will recognize that all of the backend servers can be protected with state of the art firewall techniques and private secure networks for administrative purposes.

Embodiments of the DCVM 10 can be designed to potentially support millions of clients, which is particularly important when employing communications mediums like the Internet 122 (FIG. 3). The entire DCVM 10 can be designed for high scalability and high reliability. By making use of an N-Tier approach, frontend services can be duplicated and distributed as load increases. Frontend services can also be topologically distributed, to be “close” on the Internet 122 to a maximum number of clients 12. Of course, backend centralized services can also be scaled and replicated as load increases.

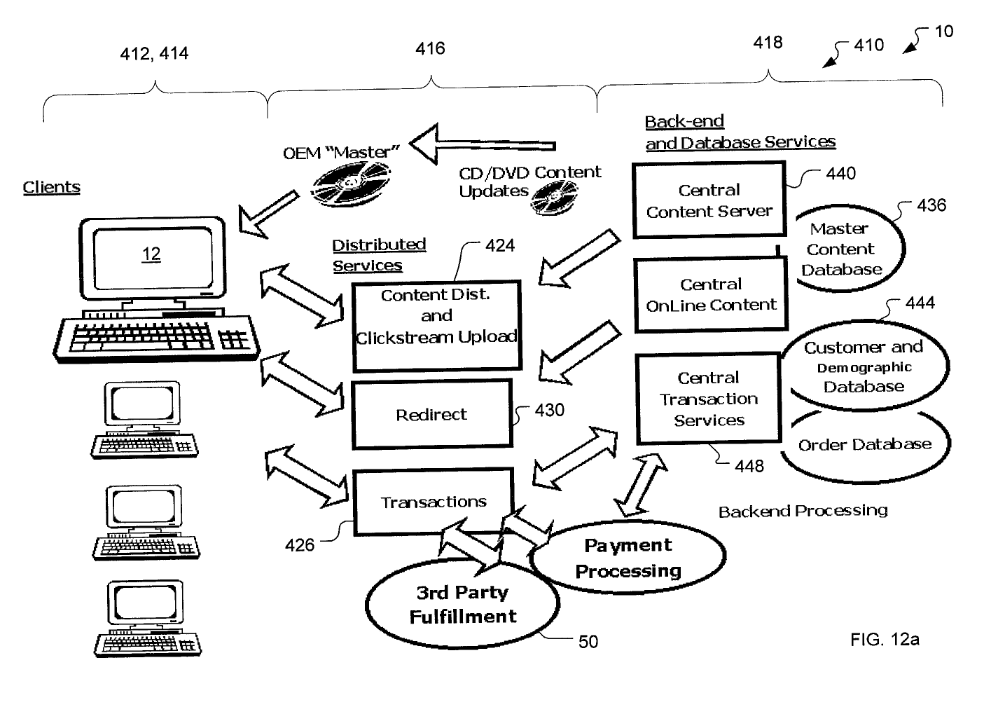

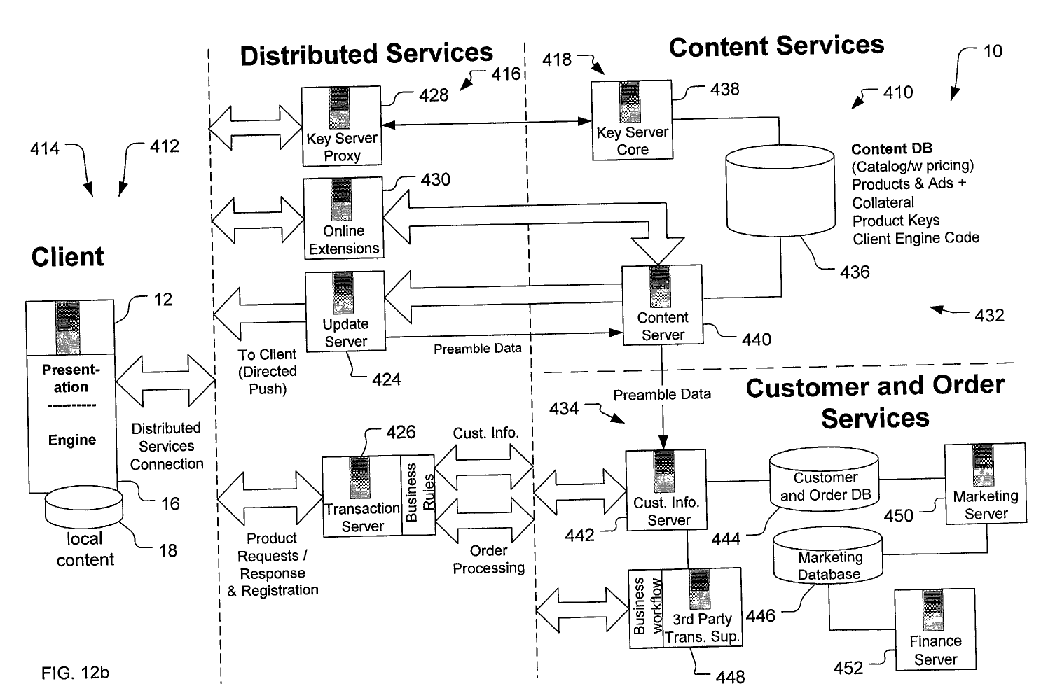

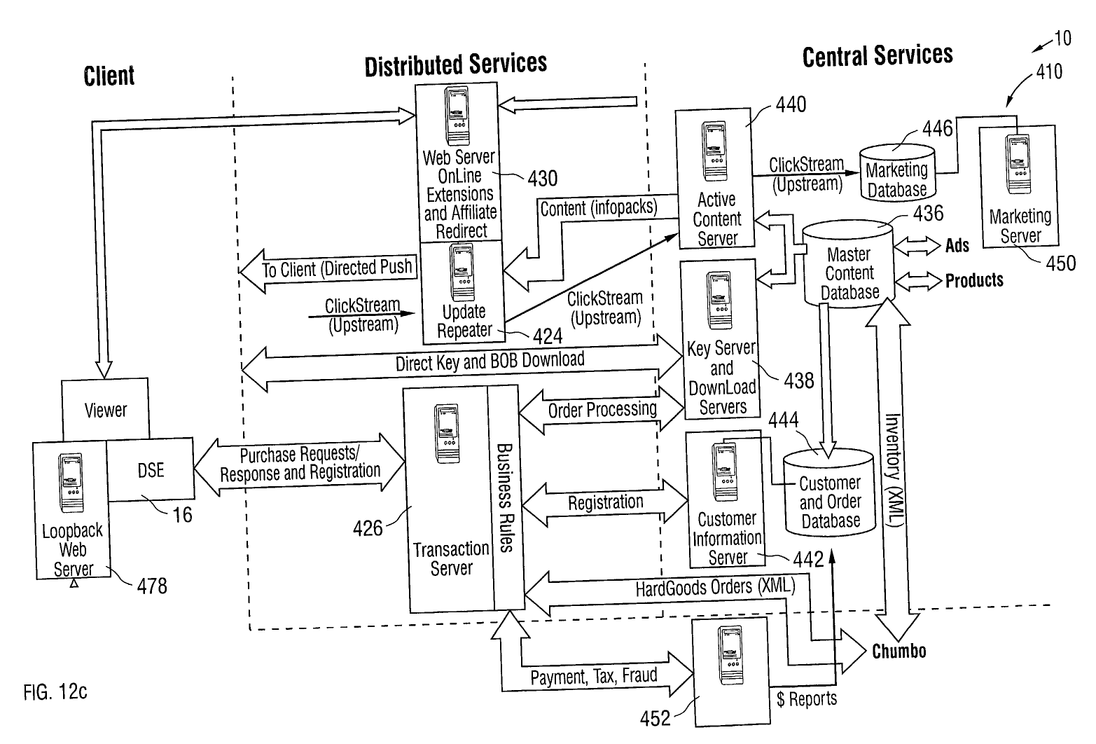

FIGS. 12a-c depict how the DCVM 10 can be implemented as an N-tier configuration 410, grouped by function and location with a first tier 412, a second tier 414, a third tier 416, and a fourth tier 418. FIG. 12a is a block diagram overview of major tier elements; FIG. 12b is a block diagram of a more detailed architecture topology overview; and FIG. 12c is a block diagram of a server oriented overview of the N-tier configuration 410.

The first tier 412 is a presentation service 420, and is resident on the client 12. This first tier 412 includes the viewer application of the DCVM 10, one which is capable of rendering dynamic HTML, along with various graphic, audio and video elements. It also includes a content manager and client management functions, as part of the “engine” or infrastructure 16.

The second tier 414 typically consists of a local “proxy” HTTP service, a client transaction agent, and content cache. The second tier 414 can also be hosted on the clients 12, or on a local proxy server system.

The third tier 416 contains distributable components and frontend servers. The frontend servers include content proxies (e.g., a push or update server 424); a transaction server 426, which handles purchases and initial registration requests; a key server 428; a contents extensions server 430; and various support (and corporate) web servers as needed.

The fourth tier 418 can be grouped into content services 432 and customer and order services 434. The content services 432 typically contain all centrally maintained active content, including “BOBs” of digital content which may be sent to clients 12 as assets 22 and keys to unlock digital wrappers 60 protecting them, advertising collateral, and presentation infrastructure. This is typically stored in content databases 436 and handled by a key server core 438 and a content server 440. Behind the content services 432 and production facilities which create and aggregate content, there are additional services such as the actual distributors and the ISVs.

The customer order and services 434 include a customer information server 442, which works with a customer and order database 444 (or multiple databases) and a marketing database 446. Behind the customer and order services 434 are the actual 3rd party fulfillment and clearing house services. Additional servers can also be provided here to provide additional services. FIGS. 12a-c illustrate this, with the customer and order services 434 here further including a 3rd party transaction server 448, a marketing server 450, and a finance server 452.

Business and transaction logic is evident through all of the tiers, starting with the first tier 412 presentation and execution of client transaction applets, communicating with a client transaction agent (executing in the engine of the second tier 414), communicating with the third tier 416 via the transaction server 426 (which hosts a server transaction agent), applying of specific business rules in the transaction server 426, and applying business rules in the customer information server 442.

The clients 12 remain self contained and may browse and shop off-line. The clients 12 may also go online at any point to also shop online or to obtain updates. Also, once a customer is ready to purchase, they are guided to a “purchase page,” and may be given the option to purchase “online,” via voice operator or via mail or fax. Customers who do choose to go online can communicate directly with four or more different types of services available. However, to a large extent, the customers are unaware of transitions between the different services and will, in fact, likely be communicating with several services simultaneously.

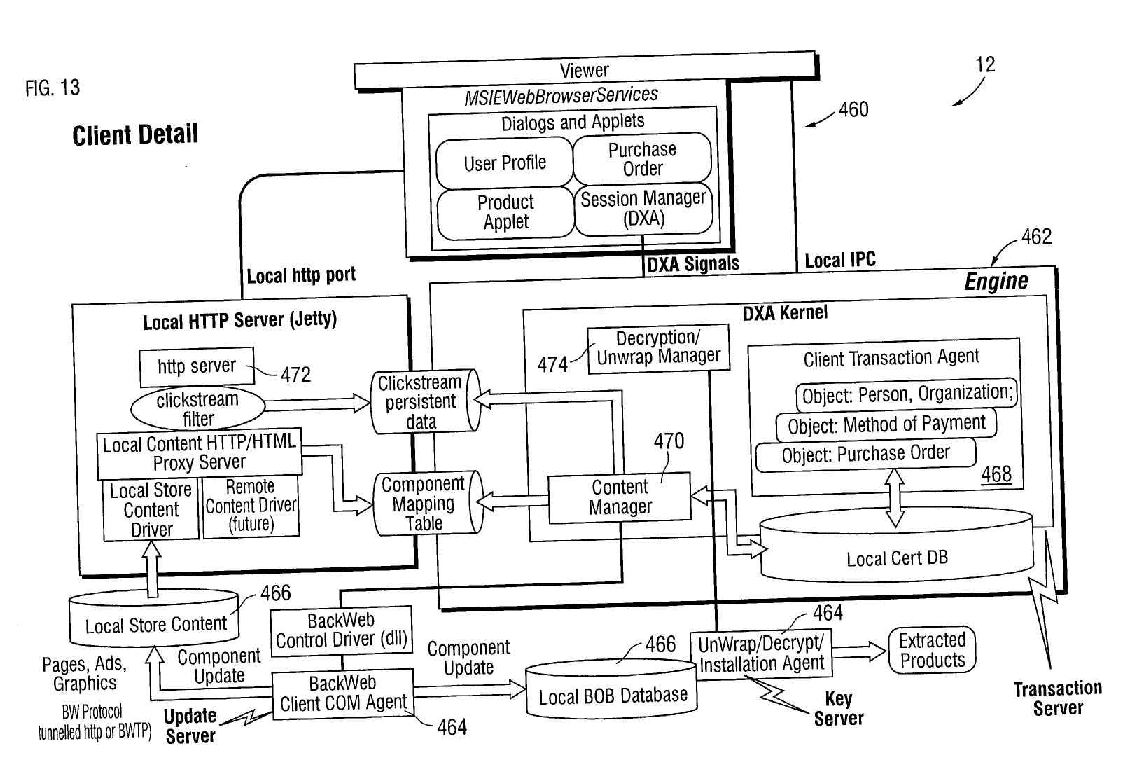

FIG. 13 is a block diagram which particularly depicts the first tier 412 and the second tier 414 of the client 12 in the embodiment of the DCVM 10 of FIGS. 12a-c. The client 12 can conceptually be decomposed into a viewer application 460, an engine 462 (essentially the infrastructure 16 simplistically represented in FIGS. 1a-b), a set of agents 464 providing access to third party technology, and a local cache 466 of the digital content and collateral (including the local inventory 18 of FIGS. 1a-b).

The viewer application 460 may be a thin application that provides viewing, browsing, script interpretation and rendering to standard “web technology” data and graphics files. In the presently preferred embodiment, the viewer application 460 makes use of built-in MICROSOFT WEB BROWSER (TM) and Microsoft's HTML services, that are also used by the INTERNET EXPLORER (TM) browser. Except in a few areas, the viewer application 460 may be identical to this browser with regard to support of HTML, cascading style sheets (CSS), JAVASCRIPT (TM) and VBscripts, JAVA applet interpretation, graphics rendering ability, and plug ins. All plug ins provided to the browser may thus automatically be available to the viewer application 460, and vice versa.

One key exception to this may be in the area of applet security, however. As a standalone application, the viewer application 460 need not be constrained by the security sandbox and rules of the browser. While this makes it easier for ones own applet development, it also creates the potential for a security hole. For this reason, the viewer application 460 may invoke a default browser whenever it follows a non-local link.

The pages for the digital content assets 22 offered. i.e., the stores 44, etc., may be constructed with a set of applets, typically including a ProductApplet, a PriceApplet, and a SessionManager. The viewer application 460 can also communicate directly only with the engine 462, communicating effectively in a loopback to a local HTTP server and a local service socket. HTTP communication occurs through the browser's HTML services. The SessionManager can handle the socket communication for the viewer application 460.

Some typical applets and associated functions include the following. A ProductApplet can provide the mechanism for adding an asset 22 from the inventory 18 (FIG. 1a) to the shopping cart, buying it immediately, or requesting more information (HTML pages) about it. A PriceApplet can present the most current pricing in an attractive format to the user. This applet queries a client transaction agent 468 (FIG. 13) in real time for up-to-date pricing information. A SessionManager applet can be responsible for populating the customer profile and for handling the method of payment, shopping cart, and purchase order. This can be a multi-threaded, invisible applet. It then can allocate additional threads for the session manager daemon and an observable helper object. A ContentManagerInterface applet can also be invisible, and present to receive a number of applet tag parameters describing the store, aisle, and product preferences for a given user during the current and subsequent sessions.

Continuing with FIG. 13, the engine 462 is the general host environment for the client transaction agent 468, a content manager 470, a proxy HTTP server 472, and a decryption manager 474 (as well as many others). In the presently preferred embodiment, all internal components of the engine 462 are developed in the JAVA (TM) language. The engine 462 then may be either a set of distinct classes run by the JAVA runtime engine (JRE) or may be compiled into one or more executables and supporting dynamic link libraries (DLLs). This preferred engine 462 is built on a JAVA defined framework named the Dagny execution architecture (DXA)(TM), from CIME Software Labs, LLC. Of course, other languages, components, and compilation methods may also be used.

A summary of key elements in the preferred engine 462 follows. The client transaction agent 468 provides the transaction integrity mechanism for the client 12 by managing: user profiles, methods of payment, and purchases. The client transaction agent 468 handles a number of threads and states and synchronizes transactions in a two-phase commit process. The proxy HTTP server 472 delivers locally stored digital content and provides a mechanism for click stream tracking. The decryption manager 474 acts as an interface and manager to a 3rd party (Preview) decryption/unwrap agent. The content manager 470 acts as an interface and manager to a 3rd party push agent.

Returning now to FIGS. 12a-c, we continue with discussion of the third tier 416. A number of concerns have motivated the inventors to use proxies in the presently preferred embodiment of the DCVM 10, and some initial comments on these are appropriate.

The DCVM 10 must preferably be robust, fault-tolerant, scalable, and avoid any single point of failure. Two ways of partially meeting these requirements are through the use of mirror sites and (caching) proxies. Mirror sites actually contain complete copies of data, and proxies work by providing a transparent front end to a central backend repository of data. The use of proxy servers provides a means of distributing load, by creating an alternate location for service. The proxy servers can be deployed in two particularly advantageous ways. First, they can be topologically distributed (e.g. US West Coast, US East Coast, Europe, etc.). Once the required information is cached, customers can be serviced more quickly from proxy sites that are topologically closer than the central site. Alternatively, multiple proxy servers can be deployed in (or close to) the central server site. As long as that central site is well placed in the Internet it is “topologically” close to all locations. In this case, the proxy servers still provide processing redundancy.

The distributed services of the third tier 416 include all of the front-end service that the client 12 (first tier 412 and second tier 414) needs to communicate with directly over the Internet 122. Included in the embodiment depicted are the the update server 424, transaction server 426, the key server 428, and the online extensions server 430. Support servers and additional web servers, such for corporate identity web sites, etc., can also be added as desired.

In the preferred embodiment, by intent and design the frontend servers do not contain, for any significant period of time, any unique or persistent information. (They may cache information for a limited period.) Instead the frontend servers are either proxies or flow-through mechanisms between the clients and the back-end services.

The preferred update server 424 is a pure proxy for a BACKWEB (TM) implemented backend “channel” (content server). The BACKWEB system used supports a central/distributed architecture where there can be one central server, distributing (read-only) to proxy servers. This supports both proprietary UDP based messages (e.g., with BACKWEB transport protocol, BWTP) and messages via tunneled HTTP. When the protocol in use is BackWeb's proprietary BWTP, a BACKWEB proxy server is used. When the protocol in use is HTTP, any proxy server may be used. BWTP is also the preferred protocol with regard to BackWeb's “polite” client agent.

The online extensions server 430 may be a standard web server, providing additional content not already available on the local clients 12. This may particularly be optional, and the BACKWEB channel may provide sufficient content extension and real time update facilities without requiring this.

The support server (integrated into the extensions server 430 in the figures) may be a standard web server providing “standard” technical support and customer support mechanisms. It can include a means of tracking open orders, requesting refunds, asking for assistance, etc. The support server may have access to customer and order database 444 via the backend customer information server 442. This site does not require any special services, and can be implemented with a standard web server such as Microsoft IIS (TM) running on WINDOWS NT SERVER (TM).

The key server 428 may be implemented using Preview Systems' ZIPLOCK (TM) server technology. This provides client support for requests for the keys 58 and digital wrappers 60, once a purchase authorization has occurred. It is preferably in place as a proxy only, and requests are “flowed through” to the backend key server using the ZIPLOCK server to server protocol.

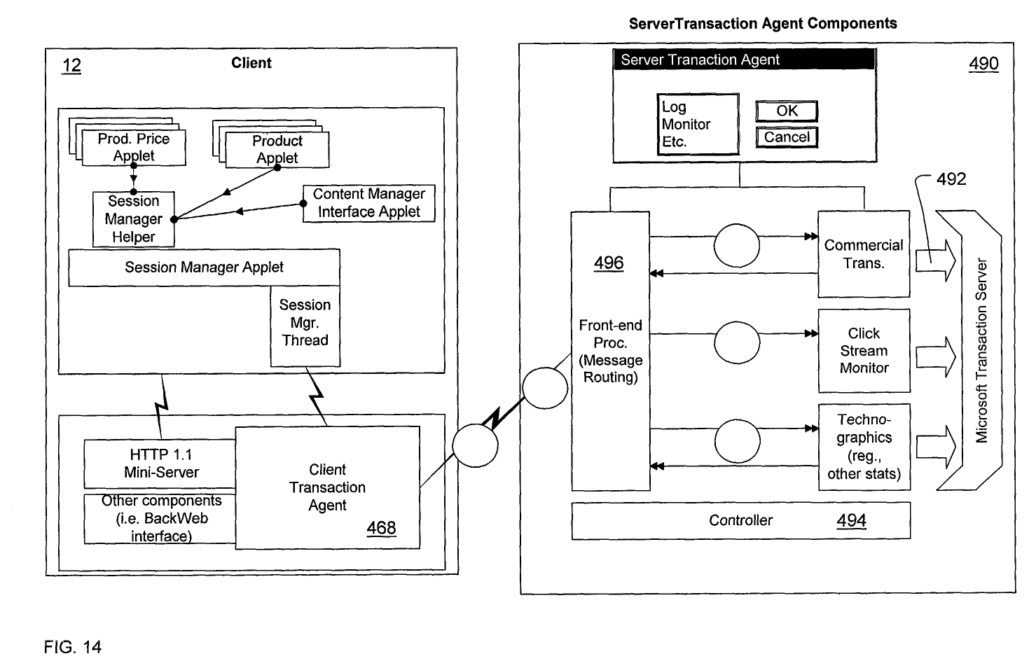

The transaction server 426 provides services for client registration, purchase and fulfillment. The purpose of the transaction server 426 is to act as a broker between the clients 12, and the back-end services of key fulfillment, clearing house activities, order handling, and customer information data services. The transaction server 426 can be decomposed into two primary components: a server transaction agent 490 and an order processing pipeline 492 (FIG. 14).

The transaction server 426 communicates with clearing house(s) through protocols typically established by a clearing house server (see e.g., clearing house 50 in FIGS. 2b and 3). In the case of CYBERSOURCE (TM), which the inventors have used in some embodiments, that protocol is SCMP. In the case of ORDERTRUST (TM), used in other embodiments, the interface is via proprietary OT SDK.

The transaction server 426 may host the server transaction agent (STA) by running it as an servlett. The STA is the server counterpart to the client transaction agent 468.

FIG. 14 is a block diagram illustrating particular agents and applets in the client 12 and the transaction server 426, and particularly includes an architecture for the server transaction agent 490.

The order processing pipeline 492 is the component responsible for executing the business logic or “rules” associated with each purchase request. The order processing pipeline 492 is concerned with completing full transaction on each order. A transaction can be thought of as a set of events that are committed or rolled back as a unit—either all of the events happen, or none of them do.

For softgoods the transaction sequence may be, approximately: credit authorization, optional fraud evaluation, order record open, key request from the ZIPLOCK server, key response (ZERT) to the client 12, and credit commit or conveyance.

For hardgoods, the order process may be a sequence of: inventory check, credit authorization, optional fraud evaluation, order placement, and order record update to the client 12.

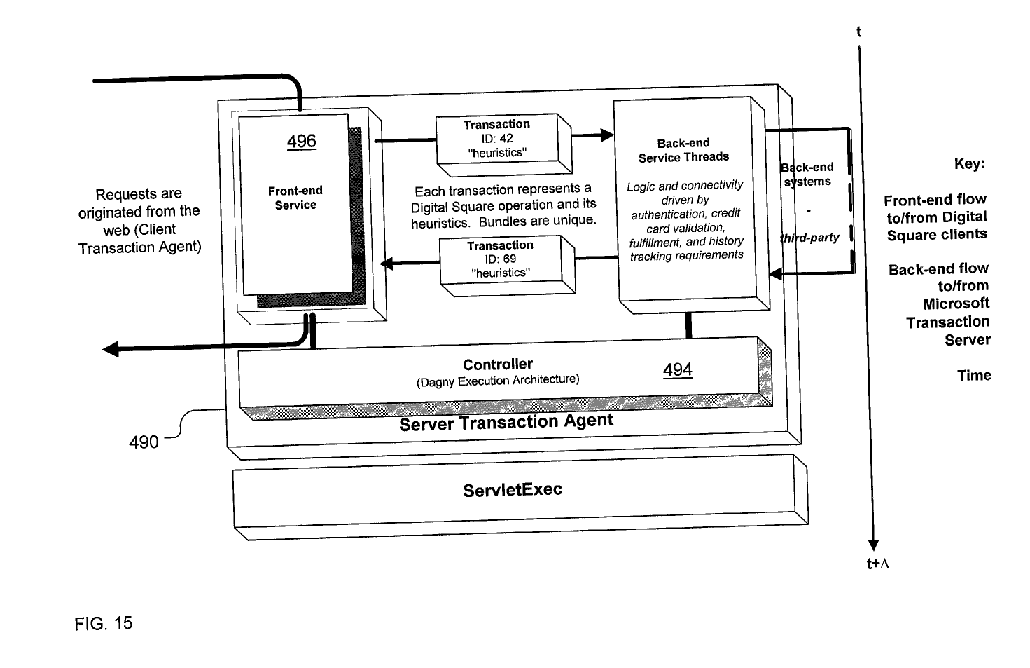

FIG. 15 is a block diagram of more detail in the transaction server 426 of FIG. 14, and is used in the following discussion. In the presently preferred embodiment of the DCVM 10, a Microsoft Transaction Server (TM) hosts the server transaction agent 490. This is in turn extended with NewAtlanta's SERVLETEXEC (TM) servlet product.

The server transaction agent 490 is implemented as a servlet that spawns a collection of threads running in a middle-tier server. This middle-tier server ties together all transaction and content flows. The server hosting the server transaction agent 490 is also preferably responsible for fault tolerance and load balancing to the back-end components.

A multi-threaded approach may be employed, wherein a controller thread is responsible for allocating all resources, proxies, interfaces, and screen widgets associated with the server transaction agent 490. A controller 494 can also manage safe execution and start and stop the service threads for the server transaction agent 490, described below. A threaded frontend service 496 can manage all interactions from the clients 12 and the master server 48 (FIG. 2b). The frontend service 496 routes all requests from the client 12 to its respective handler in the backend. The frontend service thread packages each request in a uniquely identified bundle. A commercial transaction backend can format a purchase request and forwards it in a platform-independent format to the Microsoft transaction server. A click stream monitor can forward a click stream log file from a given client 12 to its corresponding service in the backend. This thread may have “one way” flow because the click stream transmission does not have to be acknowledged by the backend as anything more than a Boolean value (failed/succeeded). A technographics service can forward purchase pattern and other customer personalization data gathered by the client 12 (browser, CTA, digital content purchase patterns, etc.) to the backend marketing engine. This thread also handles customer registration (“first time use” or “first time buyer” depending on policies set) for each user within an organization (family, work group, department, company) as defined in a business object specification.

Note, the transaction processing may particularly be asynchronous. Unique transaction IDs can be used for notifying the services and controller 494 of state changes. The services and controller thus can implement a modified observer design pattern.

The observer is a normalized method used for asynchronously notifying multiple, unrelated or loosely coupled objects, of activities running in separate threads, processes, or even computers (via CORBA or RMI) of some event, such as the completion of a transaction. Observer patterns are very good for handling large numbers of asynchronous events because resources (processor, memory, connectivity) are only consumed when there is need for them. Other alternatives, such as polling, eventually exhaust system resources by keeping the system needlessly busy.

Backend services of the fourth tier 418 include all centrally maintained digital content and databases. As briefly noted previously, the fourth tier 418 can be grouped into the content services 432 and the customer and order services 434.

With reference again to FIGS. 12a-c, the content services 432 may contain all active content, including asset 22 “BOBs” and digital keys 60, advertising collateral, and presentation infrastructure. The content services 432 are split into the content database 436, the key server core 438 (the core or one of a number of related servers) and the content servers 440 (which includes the content server and the BACKWEB channel server).

The content database 436 is the central repository of all active content. It provides active content for the key server core 438, and the content servers 440, and indirectly for all media updates to the clients 12. While this is shown graphically in the figures as a single database it may, in fact, be several databases plus a structured file system.

The content services 432 includes the core key services, as implemented using Preview Systems' ZIPLOCK (TM) server services. Once purchases are authorized, upon brokered request by the key server 428, the key server core 438 obtains a product key, wraps it uniquely for the target client 12, and provides it as the digital key 60 via the key server 428 back to the client 12. The Preview System's ZIPLOCK server system provides for a hierarchical approach to key servers, so that there is the technical option to connect to third party key servers as well, such as those hosted by distributors or hosted directly by particular ISVs.

For transaction security, all messages between components in the ZIPLOCK system are multiply encrypted with strong encryption. Each message is encrypted with a session key (90+ bit RC5) and then that key is encrypted with a public or private key (1000+ bit PKCS) before sending the message to or from ZIPLOCK server. The ZIPLOCK server maintains all private keys. No private key is ever sent, in any form or by any means, to anyone. Merchants (distributors and resellers) only receive public keys.

Each merchant account (used by a Vbox client), storefront (ZIPLOCK gateway) or remote server corresponds to a different public and private key pair, so each communication link is encrypted in a different way. Every message also has its own session key, therefore no two messages sent within the ZIPLOCK system can ever be decrypted the same way.

In present embodiments all transactions are encrypted, MIME encoded, and then sent using normal HTTP (not SSL), specifically to minimize any firewall-related problems.

The ZIPLOCK server generates the unlock key for an asset 22 automatically when an offer for an asset 22 is created. The unlock key is both stored in the ZIPLOCK server database and written out in the PID file that is used by the ZIPLOCK builder. Subsequent changes to offer data do not affect the generated key. Resale offers do not have their own keys, only offers that correspond directly to the creation of assets 22 in the inventory 18.

The ZIPLOCK builder uses the unlock key when building the BOB files for assets 22, and the Vbox client uses the unlock key when installing or reinstalling the asset 22. For security reasons, the unlock key is not put into the file. The only way to get the unlock key for an install or reinstall is through the Vbox client from the ZIPLOCK server that generated the PID file used by the ZIPLOCK builder, for all practical purposes this is an impossibility for any hacker.

ZIPLOCK System uses well-known, reliable encryption algorithms from RSA (TM) (such as RC5) at levels that cannot be cracked without some form of infeasible brute-force approach. In addition, the ZIPLOCK server employs encrypted and transparent means to deliver keys only to Vbox client. The unlock key itself is always encrypted before being sent from ZIPLOCK server to the Vbox client, and is never stored on disk at any time on the customer's machine.

A channel server (within the content server 440; FIGS. 12a-c) provides and serves updates for all collateral, infrastructure, and asset 22 BOBs to clients 12. The channel server is based on push technology. Specifically the inventors presently have chosen to use push technology from BACKWEB Technologies. In general the BACKWEB technology allows defining a “channel” of information that feeds (pushes) information to the clients 12, optionally via proxies.

The channels can be further divided with additional granularity, into “subchannels,” “infopaks” etc. BACKWEB supports scripted “extracts” of information from databases, file systems, and even external websites.

The update mechanism can be based on BACKWEB custom sub channels and “file distribution” sub channels. BACKWEB currently has some built-in support for interaction with ORACLE (TM) and INFORMIX (TM) databases. It has less direct support for Microsoft's SQL server or standard SQL scripts, but does have “automation” scripts that work with the standard MICROSOFT NT database interface, ODBC. This allows the use of any database, including Oracle and SQL that can talk to ODBC on the backend. The BACKWEB update server can either directly (via a custom BACKWEB channel) or indirectly (via a file distribution channel) pull content out of the content database 436.

The customer and order services 434 includes remote operating databases which work with the DCVM 10 (as contrasted with the also remote content database 436).

A customer database (made part of the customer and order database 444 in the embodiment represented in FIGS. 12a-c) contains a record for each registered customer of the DCVM 10, reflecting all gathered information about each registered and profiled customer. It is “fed” by the customer information server 442, and in turn “feeds” the marketing server 450 and the finance server 452.

The primary key in the customer database is a user unique ID (UID), assigned to and associated with each registered client 12. Associated with each UID are records for a computer system ID, a processor serial number, disk serial number, and additional fields as desired.

An order database (made part of the customer and order database 444 in the embodiment represented in FIGS. 12a-c) includes information about all orders, open or completed successfully, denied, or refused by the customer, aggregated from the distributed transaction server databases into a single central location. The order database is “fed” by the customer information server 442, and in turn reports to the finance server 452, the marketing server 450, and marketing database 446.

The marketing server 450 and the marketing database 446 provide profiling and real-time data-mining capability for the DCVM 10.

Each store 44 can be an assembly of several thousand assets 22 and there will be several stores 44. A fairly large inventory 18 is anticipated. In order to manage these assets 22 they may all be stored in a single central Microsoft Access (TM) or SQL database. In the preferred embodiment an internal page construction tool, based on Cold Fusion (TM) was developed that creates a set of “pages” and associated content from a named set of templates.

The inventors prefer to use outside services for clearing house activities (e.g., the distinct clearing house 50 depicted in FIGS. 2b and 3). At the current time CYBERSOURCE (TM), ORDERTRUST (TM), and INSIGHT (TM) have been identified as suitable partners for such clearing house activities, including credit card validation and fraud filtering, as well as hardgoods order fulfillment.

All store infrastructure and digital content (assets 22, ads, collateral, etc.) are first created or received by a human operator, where they are entered in the component control mechanism (e.g., AGILE (TM) or similar) hosted on a process server. Every component have an associated revision level.

Once received, it becomes part of an acceptance process. It is evaluated and tested in a number of ways, depending on the content, and its purpose. For example, advertisements are evaluated for look, size, content, and color. Store infrastructure components (e.g.. HTML and DHTML source) are tested and evaluated for correctness, as well as visual aspects. Intellectual property components are evaluated for compatibility with various targets, size, and so on. Once a component is fit for at least one build, it is “accepted”. (Note that part of the test and evaluation process is to create sample “builds”, and move to a “test” area.)

“Builds” become SKUs (literally, shelf keeping units) which comprise master(s) for various targets. An SKU will typically be required and generated for a group of OEM handled clients 12, for removable media 24 (e.g., CD 26 or DVD 28), and for target servers. In one preferred distribution model, duplication of master content onto the hard drives 20 of clients 12 can be done by the OEMs.

Registration of clients 12 typically begins the first time the customer boots up a client 12. An OEM can provide an online registration sequence for this. The registration can piggyback off that sequence (obtaining information from the OEM registration), or can follow in a natural, friendly way. An incentive can be provided to the customers to complete the registration and to connect to the registration service (on the transaction server 426). As much information as possible can be obtained without customer intervention, such as OEM, system or processor Id, disk serial numbers, time of day, followed by reasonable customer information such as name, address, phone, etc., followed by an opportunity to set profile information and to set update, privacy, and connection policy. This information is encapsulated and sent to the registration service (on the transaction server 426).

A registration service component of the transaction server 426 can digest this information, and create a unique identifier (UID) for the customer and return that UID; and forward the customer information to the customer information server 442. (Note that this UID is only for easy customer lookup. It is not used in the BOB decryption or unlock process.)

If the customer chooses not to register on-line, a parallel method for hardcopy registration can be offered. This will consist of generation of the same materials in print format, and location to fax or mail the printed registration information. The customer information server 442 will create a new customer record and the client 12 will receive the UID and store it redundantly.

Two categories of digital content will be offered via the DCVM 10: “softgoods” and “hardgoods.” Softgoods encompasses any intellectual property (IP) that can be made available to the end customer either through pre-positioned content (IP that is already at the client 12, including the assets 22 of the local inventory 18), or through electronic download (e.g., from the master inventory 104 or collateral). All softgoods will have been wrapped (e.g., encrypted) or trial injected and will need to be unwrapped (decrypted) as part of the fulfillment process. Unwrapping softgoods can be made to always require an electronic or digital key 60. That key is delivered to the customer transparently, via download to the client 12, or non-transparently via email, fax, or postal mail, or by voice. FIG. 2b provides a general overview of this.

Hardgoods encompasses all goods that require the IP, or the hardware itself to be physically provided to the customer. This definition includes software, when it is requested as an SKU from the original manufacturer. No provision (such as a custom CD) need typically be made for hardgoods delivery of digital content that exists only in softgoods electronic form.

The typical purchase and fulfillment sequence are as follows. The customer browses using the viewer application 460. The user selects assets 22 from the inventory 18 by adding them to a shopping cart, and proceeds to a checkout, or selects a “Buy Now” choice affiliated with an asset 22.

If the user is not already online the DCVM 10 initiates a connection, if possible. If the user elects to not go online, then the fulfillment initiation is via voice (human operator). The user is presented with a form asking for additional payment information, regarding how they want to pay: with a credit card number or with digital coupons.

Once the client system is online, a connection is made to the transaction server 426 and payment information is uploaded. The payment information consists of a selection of credit card and associated information, or digital credits and associated information. The asset information includes a unique asset code identifier, and the customer's understanding of the purchase price.

Upon receipt of asset information forms, the transaction server 426 imitates the order process. For softgoods, the order process is a sequence of credit authorization, optional fraud evaluation, an order record open, a key request from ZIPLOCK server, key response to the client 12, and credit commit or conveyance. For hardgoods, the order process is a sequence of an inventory check, credit authorization, optional fraud evaluation, an order placement, and an order record update to the client 12.

Following order creation, a price comparison and version comparison will be done. (The mechanics and sequence can vary. But note that while prices and version information is “pushed” to the local client 12 at every opportunity, at the time of purchase the client 12 could have stale data.) The customer is given the option to select version alternatives, and to approve or disapprove the order at this point based on the new price and availability information.

If the customer is attempting to purchase by digital credits, the transaction server 426 can also use the central customer and order database 444 to confirm or verify the digital credit balance. If the customer re-approves the transaction or is using a credit card, the central customer and order database 444 is queried by the transaction server 426 for approval. The transaction server 426, interacting with the customer and order database 444, can arrive at a decision to either (a) reject this purchase; (b) use additional credit screening to determine if this is acceptable, or (c) accept this purchase and forward handling onto the clearing house 50 for determination of taxes, etc. The transaction server 426 may use a number of factors, including time-of-day, or its own fraud check guidelines, or other factors such as response times from the clearing house 50.

Note that rejections of credit, can result in a polite response to the user along the lines of “We are Unable to Process your Credit Transaction at this time. Please call our Customer Support number at #800-xxx.xxxx.”. Legitimate purchases can be continued with the help of a customer support operator, either by overriding the fraud check, or by letting the human operator enter approval directly.

Requests to the clearing house 50 may include any of the following: (a) fraud check or screening results, (b) whether to ship or deactivate to a specified address, (c) a balance check, (d) tax collection information; and (e) preliminary approval and value amount reservation.

Finally, if all checks out, a response page is sent to the client 12 with the fully updated information. The customer is offered final approval. If the customer now disapproves, the order is closed.

If the customer approves, and the purchase was for hardgoods, the clearing house 50 is sent a request to complete the preliminary transaction, and to send an EDI message to the hardgoods fulfiller.

A brief discussion of technology incorporated into the inventors' presently preferred embodiment is now provided. However, it should be appreciated that this is essentially conventional technology which the inventors have used as component parts in just some potential embodiments of the DCVM 10, and its inclusion here should not be interpreted in any manner to limit the true scope of the present invention.

BACKWEB (TM) is a client/server system with associated tools and add-ons designed to create a framework for managing client updates, from a set of backend websites and databases. It is designed well for scalability, and extensibility, and it supports extensibility at both the client and server ends. It supports custom application development with an ActiveX (TM) SDK. In addition, its client InfoCenter can be customized and extended.

BACKWEB supports four kinds of channels: File Distribution Channels, for distribution of files and sets of files; BACKWEB Channels, for customized server hooks into other publishing or storage mechanisms such as databases; Web Channels, based on channel agents that profile and obtain specific internet/web sources; and CDF Channels, channels defined using Microsoft's Channel Definition Format language.

The ZIPLOCK ESD (TM) system is composed of several main components, one for each location involved in ESD:

| User | Location | Component |
|---|---|---|
| Customer | Customer | Vbox Client |
| Merchant (or | Merchant's | ZIPLOCK Builder |
| Publisher) | Office | |
| Distributor or | Web Storefront | ZIPLOCK ESD Gateway |
| merchant | or ESD | (formerly ZIPLOCK |
| | electronic | Merchant), ZIPLOCK |
| | warehouse | Merchandiser |
| Clearing house or | Secure Server | ZIPLOCK Server |
| Distributor | | |

ZIPLOCK components may be distributed remotely and owned or controlled by different parties, while still easily sharing transaction communications. Examples are server-to-server, ZIPLOCK ESD gateway-to-server and Vbox client-to-server.

The nature of the support can be described according to the following categories: channel authorization/configuration; how a channel sale works; and record keeping, reporting, billing and auditing.

A publisher uses the ZIPLOCK server's administration interface to grant resale authorization for its offers to the distributor. The publisher also uses the administration interface to grant a server authorization to the distributor's ZIPLOCK server.

A distributor creates resale offers on its ZIPLOCK server for the offers it wants to resell from the publisher's ZIPLOCK server. Resale offers on the distributor's server are created on ESD inventory that was registered when built on the publisher's server.

The distributor uses the ZIPLOCK server's administration interface to grant a storefront authorization to the reseller, also in the form of a digitally-signed electronic certificate. The server generates an account file containing a public key, which the distributor gives to the reseller.

The distributor grants permission to the reseller to sell offers derived from the publisher's offers. Now the reseller has permission to sell the products generally (e.g., digital content), and specific permission to do so through each appropriate storefront. The reseller also has the initial public encryption key that is used to secure the communication between ZIPLOCK gateway at the reseller and ZIPLOCK server at the distributor. A reseller using the DCVM 10 thus sets up a storefront to sell the resell offers.

The ZIPLOCK server works with other applications in the ZIPLOCK system, including the Vbox client, the ZIPLOCK builder, the ZIPLOCK merchandiser and the ZIPLOCK gateway. The ZIPLOCK server database works with MS SQL Server (TM) and other enterprise-class databases supported by Roguewave's dbtools.h++ interface package. The ZIPLOCK server is distributed with pre-configured dynamic HTML reports for use by licensees of Crystal Reports.

The ZIPLOCK server is set up to do payment processing, if desired. Merchants in the ZIPLOCK ESD system can accept all major credit cards with payment through a CYBERCASH (TM) payment processor. Each payment processor may provide services aside from payment processing, such as fraud control, tax calculation, and export control.

ZIPLOCK databases can be loaded with data from other existing databases. The server provides an API (MAC/PID) for use after the ZIPLOCK database is loaded. This API generates MAC files, .PID files, and keys used for communication and unlocking products.

The ZIPLOCK server log files keep track of system activity for use as a trouble-shooting aid. These log files can be found in the logs directory under the ZIPLOCK installation directory.

ZIPLOCK Server uses a consistent format of digital certificate across all digitally signed files. This format is called the ZERT (ZIPLOCK certificate) format. Digitally signed license files in the ZERT format are informally called, synonymously, ZERTs, ZERT license certificates, ZERT licenses, or ZERT files.

A ZERT serves as a digitally-signed proof-of-purchase. A ZIPLOCK server operator controls the information that a ZERT contains by creating a ZERT template associated with one or more offers. The ZERT template can be changed at any time, and the changes take effect immediately.

A ZERT is created for each purchase, and is delivered to the customer either along with the asset file delivery. The ZERT is created by the ZIPLOCK server but is delivered to the customer's desktop by the ZIPLOCK ESD gateway.

The license certificate for an asset 22 distributed electronically via ZIPLOCK (the ZERT) is generated by the ZIPLOCK server closest to Vbox client during a transaction, on behalf of the publisher, and is digitally signed with the reseller's private key stored on that server.

The server operator uses the ZIPLOCK server administration interface to add the “serial number” tag to a ZERT Template. The ZL_SERIAL_NUMBER database table is pre-loaded for each offer or resale that requires it.

Any database reporting package can be used with ZIPLOCK server to provide custom reports of status and activity. ZIPLOCK Server comes pre-configured to use Crystal Reports. All reports are dynamic, based on current data at the time the report is generated. Crystal Reports permits easy generation of dynamic HTML, making it a good choice for integration into the ZIPLOCK Server administration interface.

The DCVM 10 may incorporate particular behavior tracking and customer profiling capabilities. In a preferred embodiment, “clickstream” data is collected at each client 12 and uploaded on a timely basis to the core services. With reference particularly to FIGS. 12a-c and 13, a loopback server 478 and the infrastructure 16, preferably using the content manager 470, gather the data on the client 12. The content manager 470 is responsible for aggregating and collecting the data into a file, and enqueuing that file for uploading using a BACKWEB upstream facility, shown as taking place via the update server 424 and content server 440 to the marketing database 446.

The update server 424 may receive clickstream data from multiple clients 12, which it saves in a suitable file format with unique names which it creates. It should be appreciated that the choice of file format, naming convention, and other details of implementation are largely matters of design choice, but the inventors have employed the following approach.

Raw binary clickstream report files are generated at the clients 12 as serialized JAVA objects. A separate file is generated for each registered user on a client 12, and also for a default person to include click data for unregistered or unknown users. To insure unique file names, the files are named based on a customer identification, a unique random alias, and the date and time. The files preferably include two serialized JAVA objects: a ClickHeader object and a ClickDataWithLocation object. The ClickHeader object includes the customer identifier, alias, date and time, SKU ID (SKU, shelf keeping unit), system ID, a start date and end date, and the number of records. The ClickDataWithLocation object includes three arrays: an array of integer location Ids, an array of short component Ids, and an array of short click counts. For each countable soft URL (described presently) that has been located by the viewer application 460 for a user, there is an entry in each array (preferably at matching n-th locations in each array). The number of records reported in the ClickHeader object thus defines the number of entries in each array. Table 1 shows a suitable file format according to this scheme.

The serialized JAVA clickstream report files are uploaded using a BACKWEB upstream facility to the servers (the update server 424 and content server 440, ultimately to the marketing database 446). However, first it is desirable to translate the raw data into a more usable format. For this a ClickReportReader JAVA class is employed to translate the serialized data files into text files. This class is part of the content manager 470. Invoking this class with JAVA causes translation of all serialized files (e.g., those ending with “.dat”) in the current working directory into translated text files (e.g., ending in “.txt”).

Table 2 shows a sample click report file generated from test data and then translated using such a ClickReportReader JAVA class. The first line of the report is the header information. The system ID is not being used in this embodiment. The “DataTypesAndSizes” part of the header is followed by brackets around the entry to indicate that it may be a list of multiple entries (such information may not be needed, since each type of report may be identified by the “Begin” line next described). Following the header, each type of record in the file is preceded with a line that has the word “Begin” followed by the class name of the record type. And following the “Begin” line are the actual click report records, one per line.

The ClickDataWithLocation is the only type of report represented in Table 2 (but others can be easily provided). IN the report there is one line for each unique (soft) URL that has been loaded and presumably viewed. Multiple unique URLs may be associated with a single location code, and thus there can be multiple entries with the same “location.”

Using JAVA classes for the serialized data objects permits the use of access methods to extract data directly from the serialized clickstream files using a JAVA program or store procedure within a JAVA enabled database environment. For this the classes and methods in Table 3 may be used.

In present embodiments of the inventive DCVM 10 different types of click thru are provided for. A type one click thru is used to cause a navigation bar (NAVBAR) promotional to display a default browser window containing an affiliate website. The extensions server 430 then determines which particular affiliate website will be displayed by using a redirections page. The currently preferred soft URL format for this type of click thru is “NVBR_Menu_S#_A#_P#_URL_#” (e.g., NVBR_Menu_S1_A2_P3_URL_{—}4). A corresponding hard URL in the user file may then have the format “redirect://<hardURL>?<SKU>&<AD>.” The SKU entry contains the string “SKU_ID=” followed by one or more digits. Similarly, the AD entry contains the string “AD_ID=” followed by one or more digits. For example:

redirect://redirect.digitalsquare.com/adredirect.cfm?SKU_ID=1&AD_ID=2.

The action taken at the client 12 here is that the alias and customer ID are appended to the hard URL and transmitted to the HTTP request with DISPLAYBOX as the target. The URL request received by the extensions server 430 may have the format:

<hardURL>?<SKU>&<AD>&<Alias>&<CustID>.

The HTML page received from the extensions server 430 will then cause a new default browser to be created with whatever URL it specifies. The SKU and AD entries contain the strings described above. The Alias entry contains the string “Alias=” followed by one or more digits or the string “unassigned” if there is no valid value. The CustID entry contains the string “CustID=” followed by one or more digits or the string “unregistered” if there is no valid value. For example:

redirect://redirect.digitalsquare.com/adredirect.cfm? . . . SKU_ID=1&AD_ID=2&Alias=3&CustID=4.

A type two click thru is used to cause a NAVBAR promotional to display a product (asset) page. The currently preferred soft URL format for this is “NVBR_Ad_S#_A#_P#_URL_#” (e.g., NVBR_Ad_S4_A3_P2_URL_{—}1). A corresponding hard URL in the user file may then have the format “viewer:///s#/a#/pframe.html?p#/” For example:

viewer:///s4/a3/pframe.html?p2/.

The action taken by the client 12 here does not result in a HTTP request to an external web server. Rather, a specific product page stored on the hard drive is loaded into the DISPLAYBOX.

A type three click thru is used to cause a NAVBAR promotional, SPONSORBAR or ADBAR, to display a default browser window containing a non-affiliated website. The currently preferred soft URL formats for this may include:

NVBR_Ad_S#_A#_P#_URL_#,

SPBR_Ad_S#_A#_P#_URL_#, or

ADBR_Ad_S#_A#_P#_URL_#.

A corresponding hard URL in the user file here may then have the format “launch://<hardURL>.” For example:

“launch://http://www.company.com/product.htnl.”

The action taken at the client 12 here is that an instance of the default browser is started and passed the hard URL.

A type four click thru is used to cause an ADBAR or NAVBAR promotional to do nothing when clicked. The currently preferred soft URL formats for this may include:

NVBR_Ad_S#_A#_P#_URL_#,

SPBR_Ad_S#_A#_P#_URL_#,

ADBR_Ad_S#_A#_P#_URL_#, and

NVBR_Menu_S#_A#_P#_URL_#.

A corresponding hard URL in the user file here may then have the format “viewer://no_action.” The action taken at the client 12 here is that the click thru does not result in a HTTP request to an external web server.

A type five click thru is used to cause an ADBAR or NAVBAR promotional to launch a web site based on an advertisement associated with a product (asset) page. This is a POS: point of sale advertisement. The currently preferred soft URL formats for this may include:

NVBR_Ad_S#_A#_P#_URL_#, and

ADBR_Ad_S#_A#_P#_URL_#.

A corresponding hard URL in the user file here may have the format “launch://<hardURL>.” The action taken at the client 12 here is starting up an instance of the default browser and passing it the hard URL.

A type six click thru is used to cause an ADBAR or NAVBAR promotional to launch a web site based on an advertisement associated with a miscellaneous page (e.g., sitemap.html or transact.html). The currently preferred soft URL formats for this may include:

NVBR_Ad_<Page Name No Extension>, and

ADBR_Ad_<Page Name No Extension>.

For instance, NVBR_Ad_TRANSACT. Note, unlike village, store, and aisle page ads, miscellaneous page ads preferably have only one click thru location. The corresponding hard URL in the user file has the format “launch://<hardURL>,” and the action taken at the client 12 is to start up an instance of the default browser and passing it the hard URL, so the URL request received by the non-affiliated web server looks like “<hardURL>.”

We turn now to a functional description and general design description of content management for the client 12 in the DCVM 10. As has been described, a pre-installed “store” may be provided on the clients 12. One preferred approach, actually, is to provide a virtual mall or village 46 which contains multiple stores 44 (FIGS. 2a-b). The stores 44 can vend soft goods (e.g., computer software, image and text based products, music and other audio based products, and movies and other video based products). The stores 44 can also vend units of service, such as units of customer support, remote database access, e-mail service, remote web page “farming,” etc. The village 46 (at a high level) and stores 44 (at more specific, directed and tailored levels) can also provide non-overtly commercial BOBs (bags of bits). A few examples of these include advertising, coupon services, public service and other bulletin posting boards, and news group type discussion forums. Collectively, all of this and much more may be regarded and treated as digital content. To varying degrees of desirability or necessity in various embodiments of the inventive DCVM 10, such “content” has to be maintained, modified, updated, replenished, supplemented, etc. Thus, content management is an important aspect of the DCVM 10.

As a general functional base, the “store” (stores 44 and village 46 in most contemplated embodiments) resides on the customer's client 12 computer system or digital appliance. The digital content is initially present to, some degree, on the client 12. This is done either by prior installation on the system (e.g., on a hard drive when the system comes from an OEM)) or on a component added to it (e.g., on a hard drive added as an upgrade), or by installation from a removable media 24 (FIGS. 1a-b), or even by an online based installation. The digital content is stored on the client 12 in the inventory 18. This, preferably, is done using sets of files placed in a specific directory structure on the client 12. Typically, different clients 12 will be configured to subscribe to different subsets of available content, and this configuration needs to be controlled.

As a prelude to further discussion of content management, the following explanation of terminology is provided. The phrase “content manager” is a general reference to all of the client side applications and software objects which are dedicated to content management functions. In the figures (e.g., FIG. 13) a content manager 470 is depicted. BACKWEB is a third party software product which includes both server and client functionality for updating files on a client, via the Internet as an unobtrusive background task. A BACKWEB agent is the client resident part of the BACKWEB software. It monitors a client network connection and manages collection of files from a BACKWEB server. The BACKWEB agent also provides an ActiveX interface to communicate with other content management elements on the client. An “infopack” is a BACKWEB unit of updateable information. It can include multiple components, e.g., files. A “package” is a generic term for a unit of updateable information for which an atomic transfer can be guaranteed, i.e., an all or nothing download. A package may include both a digital content file and configuration information directing where that file is referenced. A “slot” is a uniquely named digital content file placed in persistent storage on the client 12, e.g., a JPEG image file. A “stream” is a selectable flow of update content, i.e., a separately subscribable flow of upgrade packages. For example, a client 12 may be configured to subscribe to an update stream of ads for a particular game type store 44. An “engine” is the general host environment on the client 12. In the figures (e.g., FIG. 13) an engine 462 is depicted. It includes a client transaction agent 468, the content manager 470, a proxy HTTP server 472, and a decryption manager 474. The inventors presently implement the internal components of the engine 462 in JAVA. These may be as a set of distinct set of classes run by a JAVA runtime engine (JRE) or they may be compiled into one or more executables and supporting DLLs. Finally, a “viewer” is an HTML based application which provides browser like functionality for viewing the village 46 and stores 44. In the figures (e.g., FIG. 13) a viewer application 460 is depicted.

In the inventor's presently preferred embodiment, the following architectural assumptions have been used. A file directory structure is used on the client 12 to locally store and retrieve the local digital content. Push technology by BACKWEB is used to provide updated digital content. Targeting of specific digital content for specific clients 12 is done using sub-channel subscription selection. The content manager 470 resides on the client 12 as part of the engine 462, where it is implemented as multiple objects accessed as needed by the engine 462. A file manager on the client 12 tracks content references and handles “garbage collection” of old files. And a file server layer in the content manager 470 translates HTML URLs into the actual digital content files.

The content manager 470 maintains user profile information as persistent data. In simpler embodiments there may be only one configuration per client 12, and in more full featured embodiments there may be multiple user configurations. The user configuration data can be combined with configuration data for the village 46 and stores 44, to control the presentation and updating of these as well. One feature typically included in the configuration data is login security for the modifying the configurations of the stores and other functions. The content manager 470 can provide a user profile dialog GUI which permits users to set their personal profiles. Such a personal profile typically will include: user name and login, interest areas, and a privacy policy (e.g., tell all, say nothing, or degrees in between).

The content manager 470 also maintains the store 44 and village 46 configuration as persistent. The content manager 470 can interact with a file manager to decrement references and delete files when a store or part of a store is removed. If an item of digital content is removed the content manager 470 can provide a link to a file identifying non-local availability for display in the store (e.g., in the views of FIGS. 7-10e). To configure this the content manager 470 can provide a store configuration dialog GUI for users to set profiles. Some typical store categories that can be included or removed are: business, games, home, hobbies, gerbils, etc. Content categories can also be included or deleted for each store, with only BOBs deleted or entire stores deleted. The frequency of store and content updates can also be specified, say, as never, as needed, or at a specified frequency.

The configuration for updates themselves is another feature the content manager 470 can permit and control. An update configuration dialog GUI can be provided to let the user set their system update parameters. One typical parameter here is the update style, including the choice of automatic background updates, automatic updates with user approval (message box OK), scheduled updates (automatic but at specific times), and manual updates initiated by the user. Another parameter is the dynamic nature of updates, including whether to enable or disable such and whether user approval is required or not. The connection style may also be configurable here, allowing auto dial connection or updating only if already online.

The content manager 470 particularly controls the updating of the digital content itself. This includes the assets 22 which are sold and the collateral which may, or may not, be associated with the assets 22. This permits updating the essence of what is displayed as the HTML based “village” and “stores.” The content manager 470 uses the user, store, and update configuration data to request specific streams of update data from a remote server (e.g., the update server 424 and the content server 440). Separate streams may exist for each combination of store, content category, and OEM installation configuration. Separately streamed content categories may include ads, product BOBs, store infrastructure (e.g., updates to the infrastructure 16 on the client 12), and pricing. Thus, for example, with five stores 44 and four content categories there will be twenty streams for each OEM configuration. If Alpa Computers and Beta Computers are two OEMs each providing systems with the DCVM 10 installed, there may be up to twenty streams each, potentially forty. Of course, however, the same streams can be used for multiple OEM configurations.

Each update stream can be made up of multiple update packages. The update packages are uniquely identifiable. The client 12 keeps a record of update packages received, and the server (e.g., the update server 424) does not generally send packages which the client 12 has already received. Each update package can include any number of files of digital content and configuration information related to it.

The package configuration information includes a list of URL, filename, and type triplets. The URL is a file reference as used in the infrastructure HTML files for the store 44. The filename is a globally unique name used for an asset 22 or other digital content file. And the type parameter specifies information such as the click stream tracking required.

The content files in an update package include the files named in a filename in the configuration list, but when update packages are sent only files that do not exist on the client 12 are actually sent. The configuration information in an update package is used to update a data structure used for HTML file retrieval. The configuration data structure links URLs used by the viewer application 460 to actual file names. A separate file manager tracks file references and provides garbage collection of old files. And a separate server layer uses this data structure to retrieve files for the viewer application 460.

The content manager 470 thus provides a highly dynamic data update capability. It interfaces to a local HTTP server interface to receive requests for non-local digital content, when that content is requested for display by the stores 44 but available on the client 12. The retrieval of requested files that are not local to the client 12 is handled through BACKWEB services or through a connection to a separate non-local HTTP server.

This discussion now turns to content management implementation. In the inventor's presently preferred embodiment the following general assumptions are employed. A file directory structure is used on the client 12 to store and retrieve the digital content. A flat “mangled” structure is used to store files with unique names. A configuration table links URLs used by the viewer application 460 to the actual files names in the file directory structure. The file structure mimics the structure on the server. The content manager 470 accesses a BACKWEB agent through a COM API. The GUI of the content manager 470 is accessed through an applet in an HTML feature in the stores 44. The content manager 470 exists as multiple objects accessed as needed by the engine 462. The user profile resides in a persistent file in a file directory on the client 12. The BACKWEB agent 464 maintains the Internet connection (in embodiments permitting this—most—, and where possible). The engine 462 and the BACKWEB agent 464 are both started at system startup, i.e., when the DCVM 10 starts and the infrastructure 16 starts.

The architecture used for content management in the DCVM 10 may be the following. Content update in the client 12 is controlled by multiple interacting software objects which are components of the engine 462. Configuration dialogs are launched as applets from the viewer application 460. Separate dialogs exist for store configuration and for user profile and update configuration. These dialogs maintain the configuration data in files or in an operating system registry, for access by other software objects. An initializer creates static objects, starts threads, registers dependencies, etc., when the engine 462 is started. A BACKWEB content bridge provides a COM ActiveX interface layer to the BACKWEB agent 464. A channel manager provides an interface between the BACKWEB and profile data. The channel manager is responsible for providing the correct sub-channel or stream subscription information to the BACKWEB agent 464. A dynamic content driver handles requests from the HTTP server layer for digital content files which are not present locally. The dynamic content driver initiates requests for the needed information to the agent 464 or to a remote HTTP server. A local HTTP server layer takes URL requests from the viewer application 460 and returns digital content files used in the stores 44. A local file manager manages additions and deletions of the digital content files. It tracks file references and deletes files only if they are no longer referenced by any URL in any store 44 (or by the village 46 itself). The BACKWEB agent 464 is a third party software product used in the DCVM 10 which provides functionality for the background updating of material on a client 12 over the Internet. An update manager insures that information in update packages received by the agent 464 is correctly placed in the proper locations and that any file location links or other configuration information is updated as needed.

A channel is a connection to a specific BACKWEB server. The DCVM 10 may employ a single or multiple channels, with each channel potentially divided into many streams. Streams are specific categories of information which can be separately subscribed to by individual clients 12. The streams may also be termed “sub-channels.” Each client 12 can subscribe to many streams. The details of the potential separate streams have already been described above. Stream selection is managed by the channel manager.

The user, store, and update profile and configuration data is stored in files or in the operating system registry on the client 12. This information can be edited with dialogs that are accessible from the viewer application 460, via applets installed in its top page.

The digital content is placed in a flat directory. Each file has a globally unique name that can be used to identify its content. The viewer application 460 accesses these files with URLs sent to an HTTP server layer. The server layer uses a configuration table to translate these URLs into the actual file names, and to return the correct file to the user. This abstraction mechanism allows new files to be easily referenced as store content is updated, without changing the various embedded URL links. This also allows a single file to be referenced by multiple URLs, and it facilitates easy file name information retrieval from the configuration table to report when users have viewed particular digital content (i.e., for the click steam reporting).

As noted previously, the information packages received include a list of URL, filename, and type triplets. An update manager can use this to insure that once any complete information package is received the configuration data is provided to the file manager and placed in the configuration table.

The information packages received from the BACKWEB server also include content files which the BACKWEB agent 464 places in the content directory on the client 12. The BACKWEB components can also insure that only new files are sent, and it can provide incremental updates of existing files. The file manager tracks file references and provides garbage collection of old files.

Large portions of the design for the sub-systems used by the content manager 470 have been implicitly covered already, but the following comments elaborate. Dialogs for the village and store configuration (i.e., system profiles), user profiles, and update configuration can be implemented as applets accessed from the viewer application 460. An initializer creates static objects, starts threads, registers dependencies, etc. A BACKWEB content bridge provides a COM wrapper and interface layer to the BACKWEB agent 464.

The channel manager provides an interface between the BACKWEB content bridge and the profile data. A channel subscription configuration runs on initialization and when the profile or configuration settings change.

The dynamic content driver provides for retrieval of needed content which is not present locally. It initiates requests for needed items to the agent 464 (alternately, conventional components and HTTP can be used for this, but using the BACKWEB approach is currently preferred). The dynamic content driver also permits a user option to cancel updates if they are greater than a certain size.

The major objects within the content manager components interface may include a local HTTP server layer, a local file manager, a BACKWEB agent, an update manager, and a remote content server. The local HTTP server layer takes URL requests from the viewer application 460 and returns store content files. The local file manager manages additions and deletions to the store content files. It tracks file references and generally deletes files only if they are no longer referenced by any URL in the village 46 or a store 44. The update manager insures that all information in the update packages is handled correctly.

The BACKWEB agent is a third party provided object which always runs on the client 12 in the embodiment being described here. The channel manager configures the BACKWEB agent using the user profiles, store configuration, and update configuration information. The profile details are used to generate a sub-channel subscription list for the BACKWEB server. A one-to-one correspondence between streams and pre-defined sub-channels can thus be provided. Based on subscription received from the BACKWEB agent on a client 12 the BACKWEB server provides “infopacks” to the client 12 with files and information which allows the BACKWEB agent to place these files in the desired directory locations. The BACKWEB agent thus manages the requesting and receiving of updates, places updates into the proper directories, guarantees the atomicity of the infopacks received, provides incremental updates of files that are already present (but not sending files that exist unchanged), sends requests for specific information to the BACKWEB server, and handles dial up connection if not online and requested by a user.

The remote content server is (in this embodiment) a BACKWEB proxy server, in turn connected to a BACKWEB channel server, which is accessed by the BACKWEB agent of the client 12 for the updates.

As has been described, the inventive DCVM 10 provides both an online and an offline viewing, browsing, and purchasing environment. The client 12 of the DCVM 10 also provides a unique and particularly powerful mechanism for advertisement distribution and display. In some regards this mechanism can conform with industry standards, such as they presently exist or are evolving, and in other regards this mechanism provides new opportunities.

The following terms and concepts are used in the following discussion. Ad objects can be grouped into those relating to placement in a GUI. Thus, with regard to placement, a content unit is a collection of one or more positions (a display region), usually associated by some logical category. Consistent with emerging industry practice, there are three types of content units: a statistically defined form called “standard” and two dynamically defined forms called “site data” and “keyword.” A location is each “rotation time slot” in a position, that is a temporal subset of a position. Each location can be filled with a single creative (the graphical element of an ad, and optionally a click thru link). A niche is a collection of one or more content units, usually associated by some logical category. A position is a display region within a viewable window. An ad position may have one or more locations. Internally, in the client 12 a position is identified with a soft URL, e.g., in the form ADBR_S#_A#_P# (other examples of such forms are covered elsewhere herein). Positions have display attributes associated with the locations, such as random or sequential. A time is associated with either a location or a position.

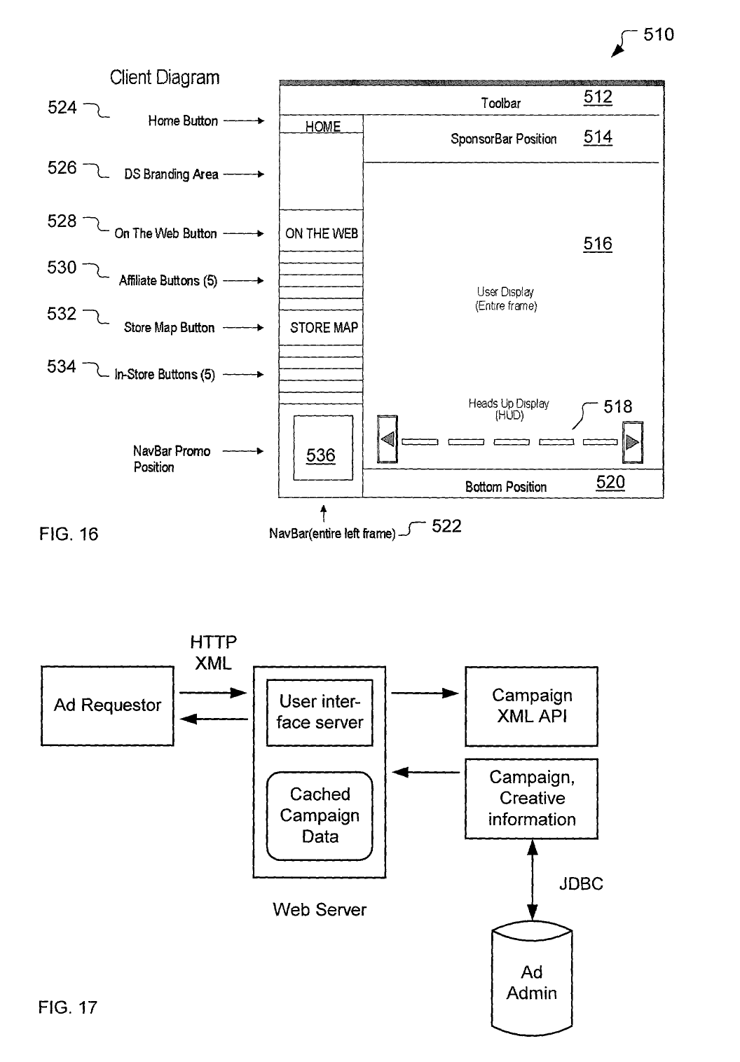

FIG. 16 is a schematic diagram depicting one screen layout (somewhat different than those depicted in the embodiment of the DCVM 10 represented in FIGS. 6-10e) which the client 12 may provide. Proceeding roughly from the top down, the screen 510 includes a toolbar 512, a sponsor bar position 514, a user display area 516, a heads up display 518 (integrated into the lower part of the user display area 516), a bottom position 520, and to the left a navigation bar 522.

The navigation bar 522 is a feature particularly germane to the present discussion. It includes a home button 524, a branding area 526, an on the web button 528, affiliates buttons 530, a store map button 532, in-store buttons 534, and a promo position 536.

Continuing with terms and concepts, and particularly now with regard to content, ads include a creative and, optionally, a click thru link. An ad package is a set of ads belonging to the same content unit, along with a store component file directing remapping and file instances. A creative is a graphical element of an ad (optionally with a click thru link). Under the prevailing usage in the industry, creatives can be “simple” or “rich media.” Simple creatives are single graphic files (e.g., type .GIF). Rich media creatives can be complex scripts, written in JAVA, JAVA script, HTML, DHTML, in addition to graphic files and redirects. A click thru link is a hypertext reference link (HREF) that names a target page to be navigated to on an ad click. A campaign set is an ad package annotated with deployment attributes.

Now with regard to actions, campaigns are actions that associate advertisers, billing attributes (e.g., rates, contacts, etc.), ads, content units, and deployment attributes. Typically campaigns are booked by a single advertiser group. With digital content distribution, the primary concern is with the association of ads, content units, and deployment attributes. A deployment attribute is a set of rules for ad display and tracking. These may be one or more of: display start date, display end date, subscription period, maximum impression count, circulation delay, duration, etc.

And now with regard to tracking and reporting, impressions occur each time the loopback server 478 (FIG. 12c) of the client 12 delivers a web page element; these are counted. Click stream reports are a message container used between the client 12 and the servers for demographic and impression or viewing count information. Aggregated click stream reports contain summations of click stream report impression count values. A large and configurable set of reports is possible, so that advertisers and publishers can track and account for ad placement in a variety of ways. Aggregated reports are primarily a concern of the backend servers and process in the DCVM 10.

A package thus is a unit of content distribution update. One term particularly avoided here is “banner.” Used in the context of placement, this is synonymous with position. Used in the context of content, this is synonymous with creative.

The client 12 supports an association of one creative per location, but this association may be reassociated with updates as part of ongoing content management. In simpler embodiments, the client 12 can dispense with support for higher level objects, such as content units and niches. Simple creatives and standard content units can be all that are provided. The store 44, aisle 164, and shelf and product level positions may also support only a few, minimal, locations per position. The click stream reports can contain OEM/SKU, revision build number, customer identifier, and impression counts associated with each store component flagged for active impression counting. All of this permits the use of simple embodiments, and particularly facilitates development of more complex embodiments.

More typical embodiments can contain campaign assignments and deployment attributes which are statically assigned and mapped via static assignments in the master content database (e.g., the master inventory 104 of FIG. 3, if this is used to save ads as general digital content). This is done before creation of a gold master copy of the client side portions (e.g., the infrastructure 16 and inventory 18 in FIGS. 1a-b) of the DCVM 10 is made, or before update package creation. Support for a circulation model can also be incorporated. For instance, the gold master copy may specify a fixed period of availability. A subscription model and an impression model may support only updates. A global circulation time period may be set for all SKUs in the gold master, say 30, days, but this may be configurable at the time of gold master creation.

The following is a high level review of end-to-end activities involved in booking, retrieving, placing, grouping, gold master deployment, updating, displaying, data aggregation, reporting, and auditing of advertisements in the DCVM 10.

Several types and variations on campaigns may be supported, including common and standard types intended to map directly into standard Internet campaign types as well as a set of new methods that particularly take advantage of the capabilities of the client 12. Click per mil (1,000) campaigns provide a means to count impressions (views) per ad or banner. This type of campaign is typically booked for a maximum global number of impressions. Counts per click campaigns may employ click thru references within HTML displays. Click thru references provided by the client 12 are counted, since these campaigns are typically booked for a maximum number of impressions or clicks. Subscription campaigns may be booked for a period of time, set to start at a particular date, run for a fixed set of days, or run until a stop date. Circulation campaigns are booked for a set number of skipping systems, i.e., for those systems in “circulation.” These typically run for a fixed number of days after the client 12 is first started, regardless of the start date. Circulation, click per mil, and counts per click campaigns can be part of an OEM gold master. Subscription, click per mil, and counts per click campaigns can be targeted to existing clients 12 in the field.

Campaigns can be booked ether directly or via a service. ADFORCE (TM) is a service available for centralizing, serving, targeting, and reporting electronic ad inventory via the world wide web. Typically advertisers, or their associated agencies, create and target campaigns to one or more websites. In the parlance of ADFORCE, a provider of website space for ads is known as a publisher, and each advertiser controls a network of websites.

The DCVM 10 is usable as a publisher, wherein space is contained in one or more websites on such a network. Logical groups of ad space are called content units, and can have attributes of display, or associated keywords with assumed semantic value, service booking and direct booking can be mixed, and the inventors have used the DCVM 10 where roughly 80% of such content units are service booked and the remainder used for direct bookings.

Direct campaigns can be placed directly in the network of the DCVM 10. One particular use here is for promotionals closely related to the DCVM 10, e.g., sweepstakes campaigns in the stores 44.

A range of types, styles, and information can be contained within a traditional campaign. Not all of these, however, work well in the DCVM 10, and not all that the DCVM 10 can facilitate fit into the traditional mold. When advertisers book campaigns through services, some sets of types may need to be excluded. Conversely, the DCVM 10 introduces capabilities which are outside the range of “normal” which most advertising account representatives are familiar with. In the following the DCVM 10 is described as it particularly may integrate with ADFORCE campaign models, but this should not be regarded as implying that the DCVM 10 is limited to just such campaigns and their features.

The ADFORCE service has been extended to provide a data broker mode of ad service, as the first step in extending to encompass distributed and third party servers. (This service is informally termed the “ad push process,” as it pushes ads to an intermediate third party.) The data broker ad service is implemented as an XML service, under this schema or protocol, third party intermediate ad servers (using the DCVM 10 can request and obtain campaign data that has been targeted to any particular ADFORCE service network or network and website. (In order to ensure security, name and password authentication is still performed, but it is done programmatically as part of the XML exchange.) FIG. 17 is a block diagram showing where the DCVM 10 can fit into an ADFORCE database and data broker scheme.

Campaign data is typically received multiple times a day, using an automatic get process run on the servers in the DCVM 10. The retrieved campaign data (including image based creatives) are resolved at this point, and the images, along with their associated flight data, are stored in an intermediate cache before being moved to the master content database using an ad manager. This opportunity may also be used to review, accept, and, if necessary, deny any campaigns that for any reason are not found desirable in the DCVM 10.

As has been discussed extensively elsewhere herein, the client 12 can be modeled as a website complete with a sitemap. The clients 12 may be modeled as a town or village square, with a set of one or more stores 44 for shopping. Custom clients 12 may be created for various users of the DCVM 10 (here distinct from the end-customers of digital content). In particular, such customers may be original equipment manufacturers (OEMs), ranging from major personal computer manufacturers to small custom system assemblers or upgrade shops. The inventors term each custom configuration a “SKU” (somewhat extending the existing industry term “shelf keeping unit”). The distributed clients 12 of the DCVM 10 may include a village 46 which contains the same set of content units, or they may define different content units for different SKUs or release levels. The content units (again) are logical associations of ad creative graphic display layout locations, and flight data is collectively the functional aspects of campaigns associated with content units.

In the DCVM 10 ad placement can be done automatically, by mapping service broker or other website content units to the content units of the DCVM 10. Once such a mapping is established, for example, campaigns booked to the websites can be “pulled” (via the data broker process) into the DCVM 10, cached to the master content database, and automatically assigned to specific SKU content units. To provide additional control, the ad manager (an interactive Internet service within the DCVM 10) provides a means for internal content managers to place ads directly (for direct campaigns) or to adjust, modify, or monitor the “automatic” campaigns.

For each OEM employing it the DCVM 10 can provide a gold master (i.e., an initialization suite) that includes the client 12, an inventory 18 (a set of wrapped and encrypted assets 22), a set of collateral for the assets 22, and an initial set of ads. This initial ad set is available for display when the end-users first run their systems with the client 12 of DCVM 10. Stated another way, the gold masters are deployed with all the content units assigned and filled with one or more ads. Any content unit that has duration minimums should have an associated ad content unit descriptor.

The DCVM 10 integrates a content distribution technology to update clients 12 in the field. This technology and how it is built in embodiments described herein using BACKWEB technology, implements additional concepts of content distribution management to control packaging and replacement of existing components. While by design nearly all of the components in the client 12 are updateable, the content distribution system is used primarily for the update of the inventory 18 of digital content assets 22, ads, and collateral for both.

The ads and associated logical collateral (such as click thru URLs, etc.), are typically grouped by campaign and content unit into a single update package. These packages are updated to the clients 12 on end-user systems using the BACKWEB technology. Part of the BACKWEB technology includes a “polite” protocol (using UDP rather than TCP/IP), which can actively update end users' systems anytime they are online, rather than only when they are in the village 46 or stores 44.

Distribution to the OEMs may be relatively straight forward, with grouping and updating via update CDs or batch download sets.

The ads, whether from the gold master base set or from updates, are effectively cached on the client 12 and displayed from the cache rather than any direct lookup or access to an ad server. The click thru ads, however, are associated with a URL. These may be of several types, including links to a location or page within the village 46 or a store 44, or links to an external website page, or those that link indirectly through a booking service or other third party redirect server.

Clicking on an external click thru ad causes the viewer application 460 to launch the user's native browser, with the named target URL. The user's default connection configuration (dialup, autodial, target ISP, etc.) takes over.

Note that click thru actions handled as redirects to booking service servers are typically counted by those servers, and the count information supplied by the DCVM 10 may be merely supplemental or used for audit purposes.

As a synopsis of ad integration, the client 12 of the DCVM 10 is capable of keeping request counts for any infrastructure 16, inventory 18, or collateral component, such as a page or graphic or redirect or URL request. Typically the request counts are kept for ad creatives and links, as well as digital content assets 22 and collateral. The request counts are ultimately aggregated into click stream reports.

The click stream reports are gathered on a per user (“person” object) basis, and are then provided periodically to the central services of the DCVM 10 via the BACKWEB upstream messaging technology. At the backend, individual click stream reports are digitally signed, parsed, and archived for use by an audit control. Parsed click stream reports are aggregated by component counts. There is a reconciliation between the component identifier and the original ad or campaign. Totals are comparable to reject and accepted values, so that cross-correlation may be done for auditing purposes.

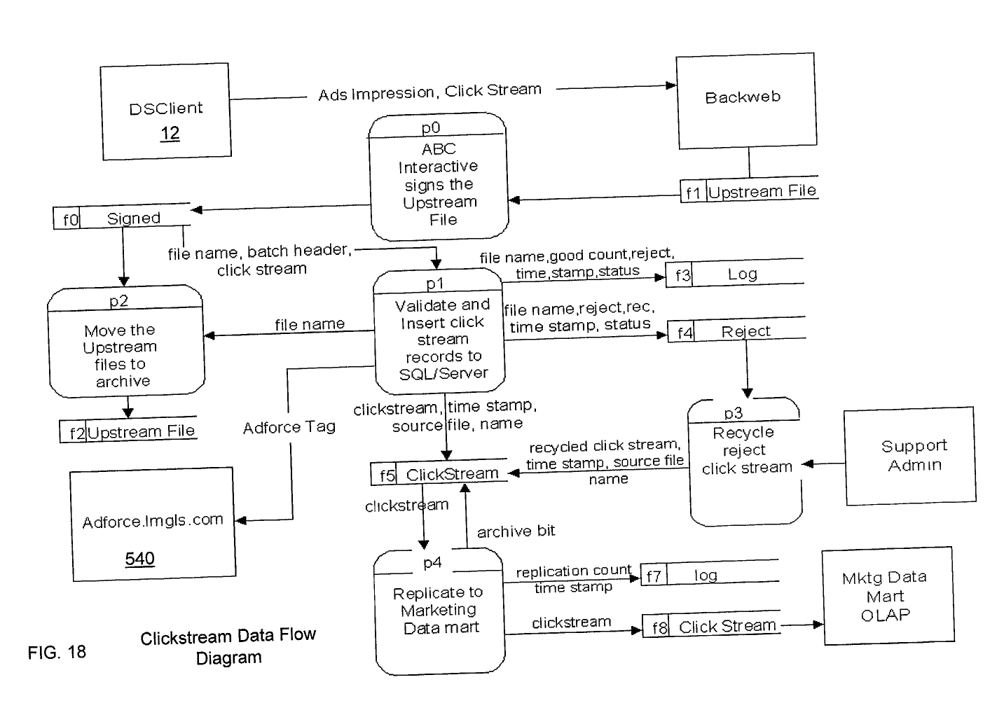

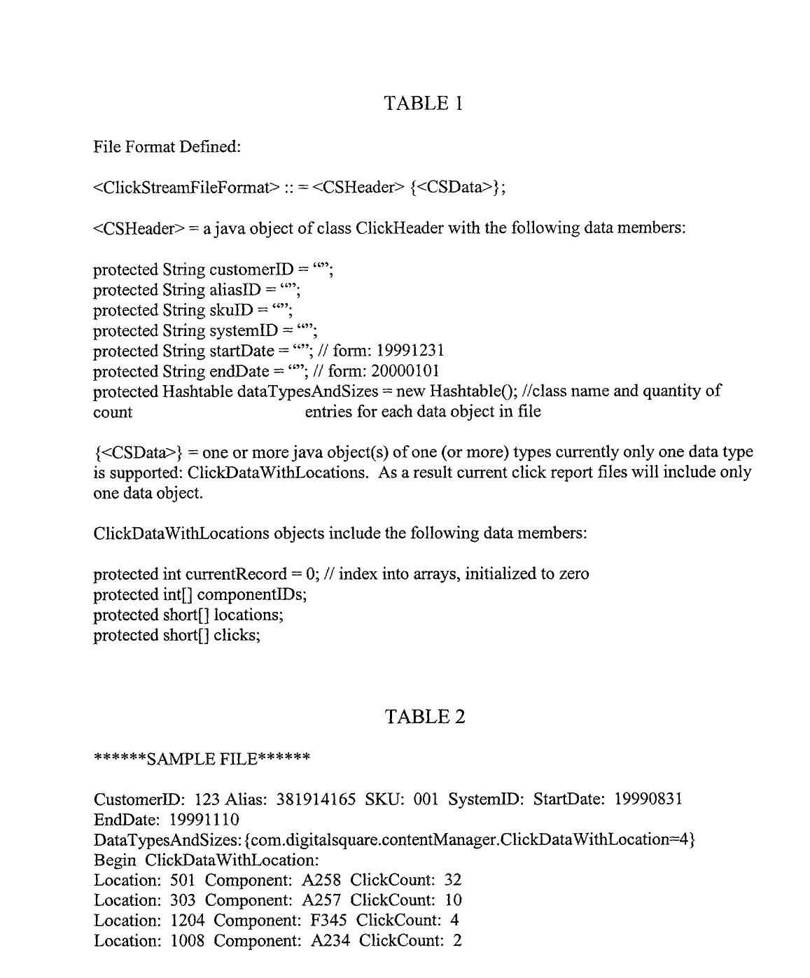

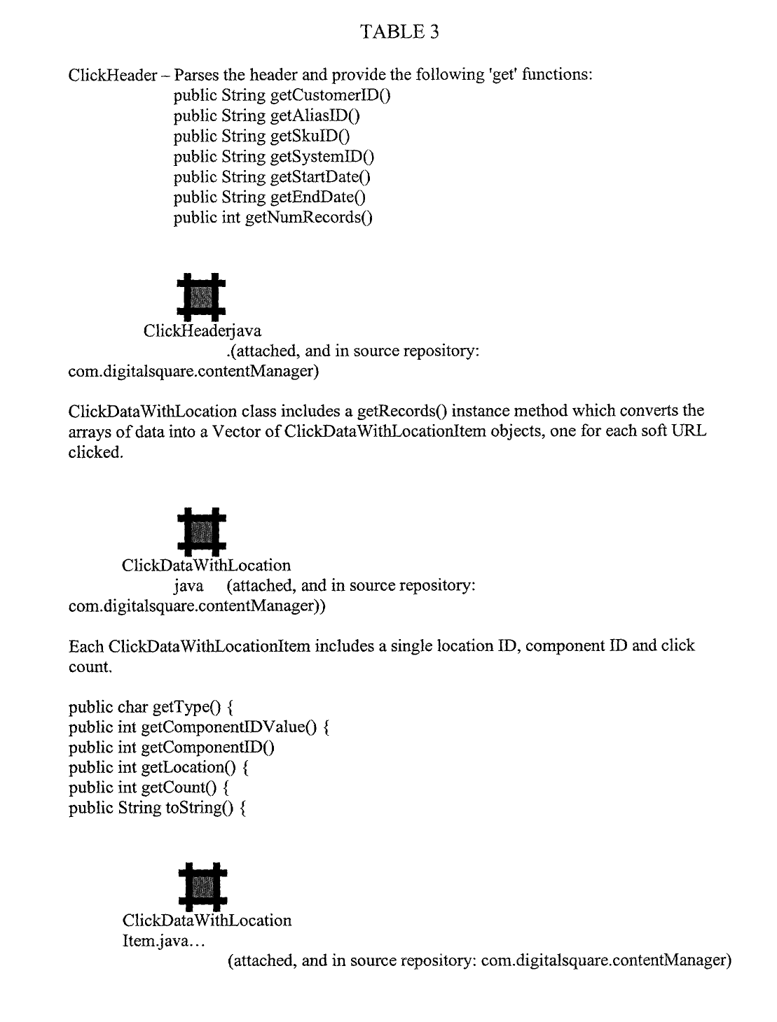

FIG. 18 is block diagram showing one possible click stream data flow approach which the DCVM 10 may use. The DCVM 10 provides for both direct reports as well as working together with a booking service such as ADFORCE.

The client 12 and end-user impression activity may be reported back to advertisers by ADFORCE. Impressions (used by click per mil campaigns) are reported through the use of a playback mechanism 540. As each click stream report is parsed and validated it is used to “playback” the same tagged HTML requests, normally executed by the end-users' browsers. This actually results in a click by click playback to the ADFORCE ad server, but a count is also keep by the DCVM 10 for validation and direct reports. Click thru references (used by counts per click campaigns) booked through ADFORCE, using a redirection server, are reported at the time they are executed at the client 12. Thus, all campaigns booked through ADFORCE can have report data available within that system (i.e., separate or in addition to that of the DCVM 10 itself). There is, however, a class of click thru ads, such as those that redirect back to the client or those that direct to non-ADFORCE servers, that are aggregated only at the reporting system of the DCVM 10, and thus are available only through direct reports.

As depicted in the flow diagram in FIG. 18, click stream and user impression data may be under audit control, with each client 12 report uniquely digitally signed, archived for a period of time, and parsed and redundantly validateable by an outside audit control group.

In another aspect of the present invention, embodiments of it may be implemented to function as a local portal. At least part of the infrastructure 16 of the client 12 on a PC 14 maybe made a persistent object, that is one which is always operating when the PC 14 is in its normal operating mode. The infrastructure 16 may then provide a visible presence on the display screen of the PC 14, a “persistent desktop object.” Persistent desktop objects (PDOs) are not new, but providing them in the manner which the present invention can is.

Since the DCVM 10 comes pre-installed in a new PC 14, or on a hard drive 20 which is later installed, the PDO may be functioning the very moment the system enters its normal operating mode. A user thus may perceive a visible and audible presence provided by the infrastructure 16 as soon as the PC 14 completes its power-up boot sequence. This is an excellent mechanism to introduce and educate inexperienced users on a new PC 14, or to welcome them as customers 40 to the stores 44 and the services of the village 46.

To some limited extent, initial user introductions are provided by many operating systems today. The “Tour” in Microsoft's Windows 95/98/ME (TM) products is a good example. Some operating systems today can also support PDOs. An example of this is can be found in the Active Desktop (TM) feature in the noted Microsoft Operating systems. However, this previously existing art can be distinguished in a number of regards.

Previously existing initial user introduction systems have not been persistent. Instead they merely run briefly as a final step in the power-up boot sequence. They also are not interactive, at least not to any appreciable degree beyond the very limited context of describing the features of the operating system itself. This is quite different than the stores 44 and village 46 of the DCVM 10 are. In particular, this does not vend, especially not in the very broad sense which the DCVM 10 can. Previously existing systems do not provide digital content in the commercial sense of offering and exchanging value for value or simply in the sense of providing access to a range of digital content from multiple sources.

Previously existing PDOs also have not been truly pre-installed. Instead they require complex setup, either as an operation following operating system installation or at some later time. Notably, few if any PCs are provided to end users with PDOs operable. Microsoft's Active Desktop (TM) provides a good example. Its basic functionality may be turned on during operating system installation, but specific PDOs then have to be chosen and enabled in a set-up operation that is daunting to even many experienced computer users. This is not “manufacturing” level pre-installation; it is post installation “configuration,” and it necessarily must be done by the end user or a party acting under their instruction for the end user to receive an acceptable result.

Content presented by such PDOs also has to be loaded. It is not initially present and, while an initial presentation (typically a welcome in the form of a web page) may be loadable from removable media, any digital content actually usable by the user must be retrieved over a communication link from a remote computer system. Furthermore, it should be noted that the initial web page presentations here are not PDOs at this stage. The user must select and enable specific PDOs related (or not) to the initial web page presentations. The end result of all of this may be very powerful, but often too powerful. It is unduly daunting to computer users, and it is just not pre-installed.

Turning back now to PDOs in the context of the present invention, a PDO may provide particular benefits if the PC 14 has access to a private network 120 or the Internet 122. If such access is always on, the PDO may receive and present material in a streaming manner. Alternately, when such access is not presently on, the PDO may use material stored locally, say, as part of the inventory 18, either as initial assets 22 or as assets received and stored at a time when previously on-line. In sum, this is a variation of the invention wherein a PDO handles a presentation to a user of the PC 14, and the inventors have termed it a “local portal.”

As for how such a local portal would appear, the possible variations are about as limitless as the range of what can be presented on the desktop of any visible display device. FIG. 6 provides a basis for discussion of one example. The village view 210 there includes the video display 214 and, if the PC 14 has a speaker, audio may accompany whatever appears in the video display 214 (audio is presumed in the rest of this discussion). The video display 214 can thus be the presence provided by the infrastructure 16. It can always be present on the desktop in the display screen of the PC 14, even when the rest of the village view 210 is gone. The video display 214 may be persistent as part of the desktop, either enlarged as the video display 214 is shown in FIG. 6 or minimized to an unobtrusive icon, even though the underlying persistent object is still at work.

In yet another aspect of the present invention, embodiments of it may be implemented to function as a micro-target for broadband content. The gist of this is that any PC 14 can be unique enough to be a target for digital content, and that content may be broadband content or it may be handled in a manner such that it is perceived to be.

As has been covered in discussing other aspects of the invention, above, the DCVM 10 provides utility as soon as a PC 14 employing it first becomes operable. The client 12, has its inventory 18 of some local digital content, and the infrastructure 16, handles local digital content and can access additional digital content on remote computer systems, e.g., the master server 70 (FIG. 3). In particular, the client 12 can “display” humanly perceivable instances of the digital content visually or audibly on the PC 14.

The client 12 may also obtain and transmit a user profile to a remote computer system. It may easily be embodied to include a mechanism to monitor the user, with respect to the PC 14 as a whole, or with respect to the DCVM 10 and the inventory 18, or even to query the user for data to include in a profile. These approaches permit deriving very accurate user profiles. Another approach is simply obtaining a profile generated on the PC 14 by other means, say from another application or from the client OS 76 (FIG. 3).

Furthermore, the invention may uniquely identify each specific PC 14 with a hardware identifier, and even specific users of respective systems with a user identifier. A hardware identifier may be based on a simple serialization of each client 12, or may be generated with an algorithm upon first use of the DCVM 10, or may requested from a remote system like the master server 70. User identifiers necessarily require a way to ascertain uniqueness of individual users, but this is easily accomplished by requesting a password from the user or determining from a client OS 76 (FIG. 3) whom a user is (typically by its previously having required a user password). In any case, identifying the target is not a difficult task and the salient point here is that the invention can easily deliver content with a granularity as fine as individual systems or individual users, i.e., a micro-targeting capability.

Still further, the invention may handle digital content which it receives form a remote computer system an a “broadband” manner. Receipt and delivery to the user of remote digital content can be essentially contemporaneous if a communications link is employed which has broad bandwidth, such as ISDN, DSL, or cable modem connections to the Internet 122, or a high speed Ethernet connection to a private network 120. As has been described elsewhere herein, streaming delivery of some digital content is also achievable. Alternately, if a communications link is employed which has narrow bandwidth, say a conventional telephone line modem, the invention still contiguous display remote digital content to the user. It can buffer remote digital content into a block for contiguous display as soon as all is received, or it can store what is received, into the inventory 18 if desired, and display can then smoothly be provided at any later time. In this manner the invention can deliver digital content which is “rich media,” as that term is used in the industry today, but without the limitations which often seriously limit prior art “rich media” delivery systems.

Therefore, invention can micro-target delivery of digital content and it can deliver broadband content, and it can combine these capabilities to be a micro-target for broadband content.

As was the case in describing the problems which the present invention can address in the Background Art section, the above discussion has primarily used PCs as an example. But the invention can solve problems beyond the context of just PCs. A PC is just one type of personal computerized device or system and a hard drive is just one type of primary storage unit. Those skilled in the relevant arts will readily recognize that the present invention can be used to initially provide and maintain, offer and vend, deliver or enable, configure and service digital content in a wide range of primary storage units and personal computerized systems (and potentially in small and enterprise networks as well). The examples noted, without limitation, in the Background Art section bear some reconsideration in view of this. Gaming stations, like Sony Playstation (TM) and Microsoft's X-box (TM) have a hard drive which can be pre-loaded with digitally wrapped game software, clue books, advertising, etc. The user can then view or use this, or may obtain a digital key to unwrap and promptly be able to use such. The same process works well for personal communication service (PCS) devices, television “set-top” boxes like WebTV (TM), Internet enabled cellular telephones; and personal digital assistants (PDAs), albeit to provide more than just game related digital content. And the same process works with “personal devices” that handle text, audio, image data and its capture, storage, playback, communication, etc.

While various embodiments have been described above, it should be understood that they have been presented by way of example only, and not limitation. Thus, the breadth and scope of the invention should not be limited by any of the above described exemplary embodiments, but should be defined only in accordance with the following claims and their equivalents.

### INDUSTRIAL APPLICABILITY

The present DCVM 10 is well suited for customers 40 with personal computers (PCs 14), and personal computerized systems, to shop at the stores 44 in the village 46. The customers 40 can browse for “best of class” software, learn new computer skills, and obtain the latest news or other information on topics of interest. It is anticipated that these digital content assets 22 will initially be primarily software and computer related services, but the underlying concept here easily extends to include music and video content, as consumers of such increasingly gain computer sophistication. For example, the stores 44 may provide top software titles (say the top 200, as determined by best seller lists), with some stores 44 specializing in children's interests, others in adult's interests, others in business interests, etc. Since top-selling (i.e., high desirability) assets 22 may be made available in the stores 44 virtually immediately, they are available at precisely the times that the customers 40 are most likely to buy—right after they purchase a system, or later as impulse or need directs. There is no driving to a store 44; the stores 44 are open twenty-four hours a day, seven days a week, 365 days a year. Shopping in the stores 44 is friendly and hassle free (e.g., there is no sales pressure); and delivery of assets 22 from the local inventory 18 is virtually instantaneous, is guaranteed, and is free. In sum, the customers 40 may receive superior service, gain confidence in, and have access to what they want (which as described below, can be pre-loaded, and even default configured, i.e., virtually assuring that it will work).

The present DCVM 10 is similarly well suited for the vendors 42. Traditional vendors 42 can easily set up stores 44 in the village 46 and concentrate on their product or service sales missions, leaving system management to the provider of the master server 48 and financial matters to the clearing house 50. Further, in the DCVM 10 the stores 44 can have potentially huge customer 40 traffic yet have very low operating cost. Thus, many additional and diverse potential vendors 42 may chose to operate stores 44 in the village 46.

The vendors 42 can also provide communications with shopkeepers, customer support, and technical support personnel in the stores 44. The DCVM 10 particularly lends itself to various marketing incentives for original equipment manufactures (OEM's) of PCs 14 and other personal computerized systems. The system builders can set up their own outlets and customer service centers (i.e., become vendors 42) in the shipped village 46 which they supply. They can also use the inherent push technology of the Internet 122 to keep these current and to promote special offers, upgrades, rebates, or software service programs. Securing a spot in the village 46 enables system builders to establish and maintain a channel of communications between themselves and their individual customers 40. Thus suppliers can easily enter the software business profitably and create an annuity stream that can continue for years. To “boot strap” the customers 40 into this new manner of commerce, one store 44 can even sell Internet subscription and setup.

The present DCVM 10 is similarly well suited for maintaining the traditional roles of the financial and governmental sectors, which are major concerns today in Internet based commerce. All transactions can be screened for fraud by the clearing houses 50, which may be operated by leading members of the financial industry. To ease commerce via licensing and to minimize disputes, or easily resolve those that do occur, the DCVM 10 may conform to the buying and license management schemes as defined by the Software Publisher's Association, thus assuring compliance with industry standards for credit card and intellectual proprietary protection. Finally, to facilitate governmental regulatory and taxation roles, the master server 48 and the clearing house 50 are highly audit able.

The key to the inventive DCVM 10 being able to function as described above is that it is stored in the PC 14 or other personal computerized system of the customer 40, thus bringing a plethora of digital content deliverable goods and services from a wide variety of vendors 42 directly to the customer 40. Accordingly, wide and rapid acceptance of the DCVM 10 can be expected.

In addition to the above mentioned examples, various other modifications and alterations of the inventive DCVM 10 may be made without departing from the invention. Furthermore, as has also been discussed herein, the inventive DCVM 10 may work in concert with or itself be a component in other inventions, such as the local portal as claimed in the present patent application. Accordingly, the above disclosure is not to be considered as limiting and the appended claims are to be interpreted as encompassing the true spirit and the entire scope of the invention.

### APPENDIX A

### Definitions

3rd Party: An individual or company not directly involved in the transaction.

Aisle: A subset of the store which contains digital content assets.

BOB: “Bag'O Bits.”

E-BOB: Encrypted BOB.

U-BOB: Unencrypted (or decrypted) BOB

BWTP: BackWeb's transport protocol.

CD: Compact Disk.

CTS: Central Transaction Server

CUS: Central Update Server

Clearing House: A partner in the purchase process who clears the financial instrument, e.g., credit or debit card.

Collateral: Displayable attributes, including but not limited to “box/icons”, ads, data sheets, 3rd party opinions, etc. All of the displayable information associated with an intellectual property or digital content, but not the item itself, plus all advertisements (including those for things other than digital content carried by the store).

DVD: Digital Versatile Disk. A high capacity removal media.

GIF: A file extension defining a graphic file. (Graphics Interchange Format).

Hardgoods fulfillment house: A partner in the purchase process who warehouses, picks, packs and ships physical product.

Hex Accumulator: Client profile “clickstream” accumulator.

Inventory: As referred to herein, a collection of digital content. In some cases collateral may be regarded as included.

ILK: Intellectual property long key.

IPP: Intellectual property provider (A software development company).

JPEG: A file extension defining a graphics file. (Joint Photographic Engineering Group).

OEM: An Original Equipment Manufacturer.

Pop-up: A window that appears overlaid on a screen. (often used to display additional required information or choices).

Digital content: Items sold directly (e.g., software products in the inventory on the client 12).

Proxy: A component or service that acts on behalf of one or more other services. Proxies generally add value by acting as repeaters and intermediate cache locations (thus reducing backend load, and reducing latency), and by filtering (thus providing security, or restricting access), or by translating (thus providing security).

HTTP Proxy: A proxy that provides service for network traffic using Hypertext Transport Protocol.

BWTP Proxy: A proxy that provides service for network traffic using BackWeb's transport protocol.

Purchase Points: Credits, e.g., funny money or “green” stamps. Rights to purchase certain digital content assets without “real money”. Purchase Points are presumably granted by OEMs or perhaps by returns.

Push Channel: A stream of data that can be received by a client system. Clients can “subscribe” to channels of data. Channels use the metaphor of “pushing” data to clients, rather than using clients to “pull” data.

Rotating Ad: A banner that provides multiple static banners each in turn.

Servers: [See separate Servers Summary, below.]

SKU: Shelf Keeping Unit, an integrated configuration of components.

Store: The second Level in the hierarchy. The store is a subset of the DCVM 10 and contains aisles.

Static Ad: A banner that does not change position or form during the viewing.

### APPENDIX B

### Servers Summary

Servers: In the preferred embodiment there are six servers, as per conventional meaning, generally, and as follows. Some of these may actually be served by the same physical system, or be distributed among several servers and distributed geographically.

Process Server: Receives, inventories, tracks intellectual property (IP products, collateral and code); verifies and accepts inventory. Tracking and versioning are done using Agile (TM) or a similar “WIP”/“Component Control” software. (Centralized. Not Distributed).

Information Services Server: This “Data Warehouse” is a repository for marketing data (e.g., revenue share, number of “views”, number of “links”, number of systems shipped). It also handles logging for customer service, and data for marketing reports, and partner reports. The centralized customer data includes a profile (including digested clickstream), credit history with VS, “purchase points,” configurations (centralized, not distributed)

Transaction Processor: Handles purchase functions for customers (credit validation, purchase points validation); Forwards to the clearing house 50 for validation when necessary. Forwards orders to hardgoods manufacturing; Or permission to Update Server. May have subset (read-only or buffered) of the customer database. (This may be distributed.)

Update/content server: Provides (free) information, collateral, and locked content updates; Provides (unlocked/purchased) updated content; Provides keys/missing data for purchased content; The “channel” or channel equivalent server resides here. (May be distributed. May be combined with the online server.)

Online server: The online (web site) village. Similar to established online web shopping sites, with the exception that entry into this site is tightly integrated with the infrastructure on the client 12. Can be created as a “standard” web server. May be the same as the update/content” server, depending on the channel design. (May be distributed.)

Support server: A support center for technical support, sales support, etc.

What is claimed is:

1. A method for operating a local portal for a user of a personal computerized system having a display, the method comprising the steps of:
(a) providing in the personal computerized system a primary storage unit containing an inventory of local digital content, wherein said inventory is pre installed in said primary storage unit before receipt there of by the user;
(b) operating a persistent desktop object which is perceivable by the user on the display of the personal computerized system; and
(c) presenting a presentation of digital content with said persistent desktop object, wherein said presentation initially includes at least part of said local digital content.

2. The method of claim 1, wherein said step (a) includes installing said primary storage unit in the personal computerized system as part of original equipment manufacture of the personal computerized system.

3. The method of claim 1, wherein said step (a) includes installing said primary storage unit in the personal computerized system as part of a n upgrade to the personal computerized system.

4. The method of claim 1, wherein the personal computerized system further has a communications link, and the method further comprising:
(d) receiving additional said digital content at the personal computerized system via said communications link from a remote computer system.

5. The method of claim 4, the method further comprising:
(e) including said additional said digital content in said presentation essentially contemporaneously, thereby streaming said additional said digital content in said presentation as it is displayed to the user.

6. The method of claim 4, after said step (d), the method further comprising:
(e) storing said additional said digital content in the personal computerized system; and
(f) including said additional said digital content in said presentation.

7. The method of claim 6, wherein said storing of said additional said digital content is into a volatile memory of the personal computerized system, and the method further comprising buffering delivery of said presentation to the user by using said additional said digital content from said volatile memory.

8. The method of claim 6, wherein said storing of said additional said digital content is into said primary storage unit of the personal computerized system, thereby permitting performing said step (f) at any time after said step (e).

9. The method of claim 8, wherein said storing of said additional said digital content is into said inventory.

10. The method of claim 1, wherein the personal computerized system further has at least one input device and said persistent desktop object is controllable by the user with said input device, and the method further comprising:
(d) building a profile of the user based on their interactive control of said persistent desktop object with respect to said digital content; and
(e) targeting said presentation to the user based on said profile.

11. The method of claim 10, wherein the personal computerized system further has a communications link, and the method further comprising:
receiving data via said communications link from a remote computer system about an available plurality of said digital content;
and wherein said step (e) includes:
requesting additional said digital content from said available plurality of said digital content based on said profile, via said communications link from said remote computer system;
receiving said additional said digital content; and
including at least some of said additional said digital content in said presentation, thereby tailoring said presentation to the user based on their said profile.

12. The method of claim 10, wherein the personal computerized system further has a communications link, and wherein said step (e) includes:
transmitting at least part of said profile to a remote computer system via said communications link;
receiving additional said digital content based on said at least part of said profile; and
including at least some of said additional said digital content in said presentation, thereby tailoring said presentation to the user based on their said profile

13. A local portal system for a user, comprising a personal computerized system including:
a display;
a primary storage unit containing an inventory of local digital content, wherein said inventory is pre installed in said primary storage unit before receipt there of by the user;
logic that operates a persistent desktop object perceivable on said display by the user; and
logic that presents a presentation of digital content with said persistent desktop object, wherein said presentation initially includes at least part of said local digital content.

14. The local portal system of claim 13, wherein said personal computerized system further includes:
a communications link; and
logic that receives additional said digital content at said personal computerized system via said communications link from a remote computer system.

15. The local portal system of claim 14, wherein said personal computerized system further includes:
logic that includes said additional said digital content in said presentation essentially contemporaneously, thereby streaming said additional said digital content in said presentation as it is displayed to the user.

15. The local portal system of claim 14, wherein said personal computerized system further includes:
logic that stores said additional said digital content in the personal computerized system; and
logic that includes said additional said digital content in said presentation.

16. The local portal system of claim 15, wherein said personal computerized system further includes:
a volatile memory suitable for storing said additional said digital content; and
logic that buffers delivery of said presentation to the user by using said additional said digital content from said volatile memory.

17. The local portal system of claim 14, wherein said additional said digital content is stored in said primary storage unit of the personal computerized system.

18. The local portal system of claim 17, wherein said additional said digital content is added to said inventory.

19. The local portal system of claim 13, wherein said personal computerized system further includes:
an input device suitable for the user to control said logic that operates said persistent desktop object;
logic that builds a profile of the user based on their interactive control of said persistent desktop object with respect to said digital content; and
logic that targets said presentation to the user based on said profile.

20. The local portal system of claim 19, wherein the personal computerized system further includes:
a communications link;
logic that receives data via said communications link from a remote computer system about an available plurality of said digital content;
logic that requests additional said digital content from said available plurality of said digital content based on said profile, via said communications link from said remote computer system;
logic that receives said additional said digital content; and
logic that includes said additional said digital content in said presentation, thereby tailoring said presentation to the user based on their said profile.

21. The local portal system of claim 19, wherein the personal computerized system further includes:
a communications link;
logic that transmits at least part of said profile to a remote computer system via said communications link;
logic that receives additional said digital content based on said at least part of said profile; and
logic that includes said additional said digital content in said presentation, thereby tailoring said presentation to the user based on their said profile.
